(19) United States
(12) Patent Application Publication
(10) Pub. No.: US 2014/0021191 A1
(43) Pub. Date: Jan. 23, 2014

(54) System and Method for a Programmable Counter-top Electric Oven and Dehydrator

(71) Applicants: Jung S. Moon, Buffalo Grove, IL (US); Eung Yub Cha, Glenview, IL (US); Byung G. Choi, Vernon Hills, IL (US); Mikale K. Kwon, Glenview, IL (US); Eunjung Huh, Gurnee, IL (US)

(72) Inventors: Jung S. Moon, Buffalo Grove, IL (US); Eung Yub Cha, Glenview, IL (US); Byung G. Choi, Vernon Hills, IL (US); Mikale K. Kwon, Glenview, IL (US); Eunjung Huh, Gurnee, IL (US)

(73) Assignee: HEARTHWARE, INC., Libertyville, IL (US)

(21) Appl. No.: 13/832,775

(22) Filed: Mar. 15, 2013

Related U.S. Application Data
(63) Continuation-in-part of application No. 12/506,628, filed on Jul. 21, 2009.
Application No. 12/506,628 is a continuation-in-part of application No. 11/987,487, filed on Nov. 30, 2007, now Pat. No. 7,964,824.
Application No. 11/987,487 is a continuation-in-part of application No. 29/415,482, filed on Mar. 11, 2012.
Application No. 29/415,482 is a continuation-in-part of application No. 13/277,212, filed on Oct. 19, 2011.
(60) Provisional application No. 61/470,493, filed on Apr. 1, 2011.

(51) Int. Cl. F24C 7/08; A47J 37/06; A23L 3/54

(52) U.S. Cl. CPC F24C 7/088; F24C 7/081; A23L 3/54; A47J 37/0629
USPC 219/392; 99/331; 34/553; 34/220; 34/238; 219/413

(57) ABSTRACT

A system and method directed to a countertop oven comprising a powerhead or power unit, a dome, and a base, which may include a stainless steel pan, and/or a plastic base, adaptable to receive a dehydrating adapter, base, and/or one or more dehydrator trays. According to exemplary embodiment, the powerhead may include a sensor to detect when the powerhead has been inserted in the dehydrator adapter, according to an exemplary embodiment. The power unit may be detachably connectable to the dehydrating enclosure and a cooking enclosure dome. The power unit and the cooking enclosure may collectively combine into a multi-stage counter-top electric oven. The power unit and the dehydrating enclosure may also collectively combine into a dehydrator. The dehydrating enclosure may include a plurality of stackable dehydrating trays through which dehydrating air is circulated from the power unit.

### CROSS REFERENCE TO RELATED APPLICATIONS

The present invention is a continuation-in-part of U.S. patent application Ser. No. 12/506,628, filed Jun. 21, 2009, entitled “System and Method for Programmable Counter-top Electric Dehydrator,” to Moon, which is a continuation-in-part of U.S. patent application Ser. No. 11/987,487, entitled “System, Method and Computer Program Product for Programmable Counter-top Electric Oven,” to Moon, filed Nov. 30, 2007, this application is also related to, and claims priority to as a continuation-in-part of U.S. Design patent application Ser. No. 29/415,482, filed Mar. 11, 2012, which claims priority to U.S. patent application Ser. No. 13/277,212, filed Oct. 19, 2011, which is itself a continuation-in-part of the U.S. NonProvisional patent application Ser. No. 12/506,628, filed Jul. 21, 2009, and the U.S. application Ser. No. 29/415,482, also claims the benefit under 35 U.S.C. Section 119(e) of U.S. Utility Provisional Patent Application 61/470,493, filed on Apr. 1, 2011, all of which are of common assignee to the present invention, and the contents of all of which are incorporated herein by reference in their entireties.

### BACKGROUND

1. Field

The present invention relates generally to countertop ovens and dehydrators, and more particularly to food ovens and dehydrators.

2. Related Art

Dehydrating food is well known in the art. Recently, mechanical dehydrators have been developed for use in the home. However, conventional dehydrators are limited in their utility because they are designed to dehydrate food, not cook food like an oven. Although, conventional counter-top ovens heat food, it is not practical to dehydrate food in a conventional counter-top oven for numerous reasons including safety, quality and efficiency. What is needed is a dehydrator that overcomes shortcomings of conventional dehydrators.

### SUMMARY OF THE INVENTION

The present invention sets forth various exemplary embodiments of apparatuses, systems, and methods for dehydrating.

An exemplary embodiment of the present invention sets forth a power unit for cooking or dehydrating. The power unit may include a power source disposed inside the power unit and a control source operable to control the power source. The power unit may also be detachably connectable to a cooking enclosure and a dehydrating enclosure.

In accordance with an exemplary embodiment, the power unit may be a power head. In an exemplary embodiment, the power source may include a heating unit and a fan unit.

According to an exemplary embodiment, the heating unit may include a heating element operable to provide heat to an enclosure, the enclosure comprising any one of the cooking enclosure and the dehydrating enclosure; and a thermostat system operable to measure an internal temperature of the enclosure and provide an input thereof to the control source.

In an exemplary embodiment, the thermostat system may include a thermistor operable to measure the internal temperature of the enclosure and a thermostat adjustable to set a desired temperature of the enclosure.

According to an exemplary embodiment, the fan unit may include a fan chamber and a fan mounted in the fan chamber operable to create a dehydrating air flow throughout any one of: the cooking enclosure and the dehydrating enclosure.

In an exemplary embodiment, the control source may include a sensor operable to determine whether the power unit is connected to the cooking enclosure or the dehydrating enclosure.

According to an exemplary embodiment, the control source limits a maximum desired temperature of the dehydrating enclosure when the power unit is coupled with the dehydrating enclosure.

In an exemplary embodiment, the sensor may include a switch with a first activation status when the power unit is coupled with the heating enclosure and a second activation status when the power unit is coupled with the dehydrating enclosure.

According to an exemplary embodiment, the switch may include a stand coupled to the power unit, an actuator sensor coupled to the stand, and an actuator coupled to the stand to trigger the actuator sensor depending on whether the cooking enclosure or the dehydrating enclosure is connected to the power unit.

In an exemplary embodiment, the power unit may be connected to the cooking enclosure and the control source may include an input interface operable to receive a multi-stage cooking recipe, a storage device operable to store the multi-stage cooking recipe, and a processor operable to cause the power source to execute the multi-stage cooking recipe.

According to an exemplary embodiment, the power unit and the cooking enclosure may collectively comprise a multi-stage counter-top electric oven.

In an exemplary embodiment, the power unit and the dehydrating enclosure may collectively comprise a dehydrator.

In an exemplary embodiment, the control source may include an input interface operable to receive a multi-stage dehydration process, a storage device operable to store the multi-stage dehydration process, and a processor operable to cause the power source to execute the multi-stage dehydration process.

According to an exemplary embodiment, the control source may be operable to notify a user to change the position of at least one dehydrating tray comprising the dehydrating enclosure.

Another exemplary embodiment of the present invention sets forth a dehydrating unit. According to an exemplary embodiment, a dehydrating unit may include a dehydrating enclosure and a power unit. The power unit may include a power source disposed inside the power unit and a control source operable to control the power source. The power unit may be detachably connectable to: the dehydrating enclosure and a cooking enclosure.

In an exemplary embodiment, the dehydrating unit may also include an adapter operable to detachably couple the power unit and the dehydrating enclosure.

Another exemplary embodiment of the present invention sets forth a dehydrating device. A dehydrating device may include a dehydrating enclosure and an adapter operable to connect the dehydrating enclosure to a power unit. The power unit may include a power source disposed inside the power unit and a control source operable to control the power source. The power unit may be detachably connectable to: the dehydrating enclosure and a cooking enclosure.

In an exemplary embodiment, the dehydrating enclosure may include at least one dehydrating tray.

According to an exemplary embodiment the dehydrating tray may include: a substantially radial raised outer wall, the wall forming a plurality of openings on the top portion thereof, the wall comprising a plurality of latches on the bottom portion thereof, the latches operable to connect with one or more openings on the top portion of a second dehydrating tray positioned on the bottom of the dehydrating tray.

In an exemplary embodiment, the dehydrating tray may form a substantially radial raised inner ring positioned in a center portion of the outer wall, the inner ring being fixedly and detachably mountable to a second dehydrating tray positioned on top thereof.

According to an exemplary embodiment, the inner ring comprises a substantially vertical wall forming one or more spaces circulating dehydrating air between a central portion of the dehydrating tray and an orifice defined by the substantially vertical wall and through which orifice dehydrating air is blown downward from the power unit.

In an exemplary embodiment, the dehydrating tray may include a substantially flat inner loop portion coupling the radial raised outer wall to the radial raised inner ring, the flat inner loop portion including a plurality of surfaces having openings therebetween.

According to an exemplary embodiment, the dehydrating enclosure may further comprise one or more additional dehydrating trays respectively stacked on top of one another and said at least one dehydrating tray.

A exemplary embodiment of the present invention sets forth a production process. The process may include producing a dehydrating enclosure and combining the dehydrating enclosure with a power unit. The power unit may include a power source disposed inside the power unit and a control source operable to control the power source. The power unit may be detachably connectable to: the dehydrating enclosure and a cooking enclosure.

A exemplary embodiment of the present invention sets forth another production process. The process may include producing a power unit and combining the power unit with a dehydrating enclosure. The power unit may include a power source disposed inside the power unit and a control source operable to control the power source. The power unit may be detachably connectable to: the dehydrating enclosure and a cooking enclosure.

Further features and advantages of the invention, as well as the structure and operation of various embodiments of the invention, are described in detail below with reference to the accompanying drawings.

### BRIEF DESCRIPTION OF THE DRAWINGS

The foregoing and other features and advantages of the invention will be apparent from the following, more particular description of various exemplary embodiments, including a preferred embodiment of the invention, as illustrated in the accompanying drawings wherein like reference numbers generally indicate identical, functionally similar, and/or structurally similar elements.

FIG. 1 depicts an exemplary embodiment of a perspective view of a counter-top infrared electric oven, according to an exemplary embodiment of the present invention;

FIG. 2 depicts an exemplary embodiment of an exploded view of the oven shown in FIG. 1, according to an exemplary embodiment of the present invention;

FIG. 3 depicts an exemplary embodiment of a section view of the oven shown in FIG. 1, according to an exemplary embodiment of the present invention;

FIG. 3A depicts an exemplary embodiment of an enlarged view of the area indicated by lines 3A-3A in FIG. 3, according to an exemplary embodiment of the present invention;

FIG. 4 depicts an exemplary embodiment of a perspective view of an oven pan of the oven shown in FIG. 1, according to an exemplary embodiment of the present invention;

FIG. 5 depicts an exemplary embodiment of an exploded view of a power head of the oven shown in FIG. 1, according to an exemplary embodiment of the present invention;

FIG. 6 depicts an exemplary embodiment of an enlarged view of the area indicated by lines 6-6 in FIG. 3, according to an exemplary embodiment of the present invention;

FIG. 7 depicts an exemplary embodiment of a diagrammatic representation of the operating components of the oven shown in FIG. 1, according to an exemplary embodiment of the present invention;

FIGS. 8A-B depicts exemplary embodiments of heat element arrangements, according to an exemplary embodiment of the present invention;

FIGS. 9A-D depicts exemplary embodiments of perspective views illustrating the mounting and the removal of a protective grid of the oven shown in FIG. 1, according to an exemplary embodiment of the present invention;

FIG. 10 depicts an exemplary embodiment of a perspective view of an optional embodiment of a base for the oven shown in FIG. 1, according to an exemplary embodiment of the present invention;

FIG. 11 depicts an exemplary embodiment of an enlarged, fragmentary section view taken substantially along line 11-11 in FIG. 10, according to an exemplary embodiment of the present invention;

FIG. 12 depicts an exemplary embodiment of a perspective view of another optional embodiment of a base 10 for the oven shown in FIG. 1, according to an exemplary embodiment of the present invention;

FIG. 13 depicts an exemplary embodiment of an enlarged, fragmentary section view taken substantially along line 13-13 in FIG. 12, according to an exemplary embodiment of the present invention;

FIGS. 14A-B depict an exemplary embodiment of isometric views of exemplary embodiments of the present invention;

FIG. 15 depicts an exemplary embodiment of an isometric exploded view of an exemplary embodiment of the present invention;

FIGS. 16A-16B depict a front and side view of an exemplary embodiment of the present invention;

FIG. 17 depicts an exemplary embodiment of an input interface of an exemplary embodiment of a multi-stage cooking electric oven;

FIG. 18 depicts an exemplary embodiment of a numeric display panel of an exemplary embodiment of a multi-stage cooking electric oven;

FIG. 19 depicts an exemplary flowchart of a basic overview of an exemplary embodiment of a multi-stage cooking recipe algorithm executable by an exemplary control system of an exemplary counter-top oven;

FIG. 20 depicts an exemplary flowchart of an exemplary way exemplary delay stage, sear stage and warm stage input parameters of a multi-stage cooking recipe may be received;

FIG. 21A-C depict exemplary flowcharts of exemplary ways exemplary stage input parameters of a multi-stage cooking recipe may be received;

FIG. 22 depicts an exemplary flowchart of an exemplary way exemplary cooking stage input parameters of a multi-stage cooking recipe may be received;

FIG. 23A-B depict exemplary front and side views of an exemplary embodiment of a dehydrator;

FIG. 24 depicts an exemplary sectional view of an exemplary embodiment of an exemplary dehydrator;

FIG. 25 depicts an exemplary top view of an exemplary embodiment of an exemplary dehydrator;

FIG. 26 depicts an exemplary perspective view of an exemplary embodiment of an exemplary adapter for an exemplary dehydrator;

FIG. 27 depicts an exemplary perspective view of an exemplary embodiment of an exemplary sensor for an exemplary power unit;

FIGS. 28A-B depict exemplary side views of an exemplary embodiment of an exemplary sensor coupling with an exemplary dehydrating enclosure;

FIGS. 29A-B depict exemplary perspective views of an exemplary embodiment of an exemplary sensor coupled with an exemplary cooking enclosure;

FIG. 30A depicts an exemplary embodiment of an improved user interface for a countertop oven illustrating various exemplary features and functions, which may include, according to an exemplary embodiment, LCD display, numeric keys, COOK TIME button, START button, COOK TEMP button, PROG button, DELAY button, SEAR button, PAUSE/CLEAR button, MEMORY button, WARM button, DEHYD (dehydrator mode) button, RECALL button, REHEAT button, and/or STAGE button, according to another exemplary embodiment;

FIG. 31 illustrates an exemplary user interface illustrated on an exemplary oven power head, according to an exemplary embodiment;

FIG. 32 illustrates an exemplary closeup of an exemplary user interface, according to an exemplary embodiment;

FIG. 33 illustrates an exemplary closeup of a portion of an exemplary user interface, illustrating an exemplary central circular button within each exemplary button;

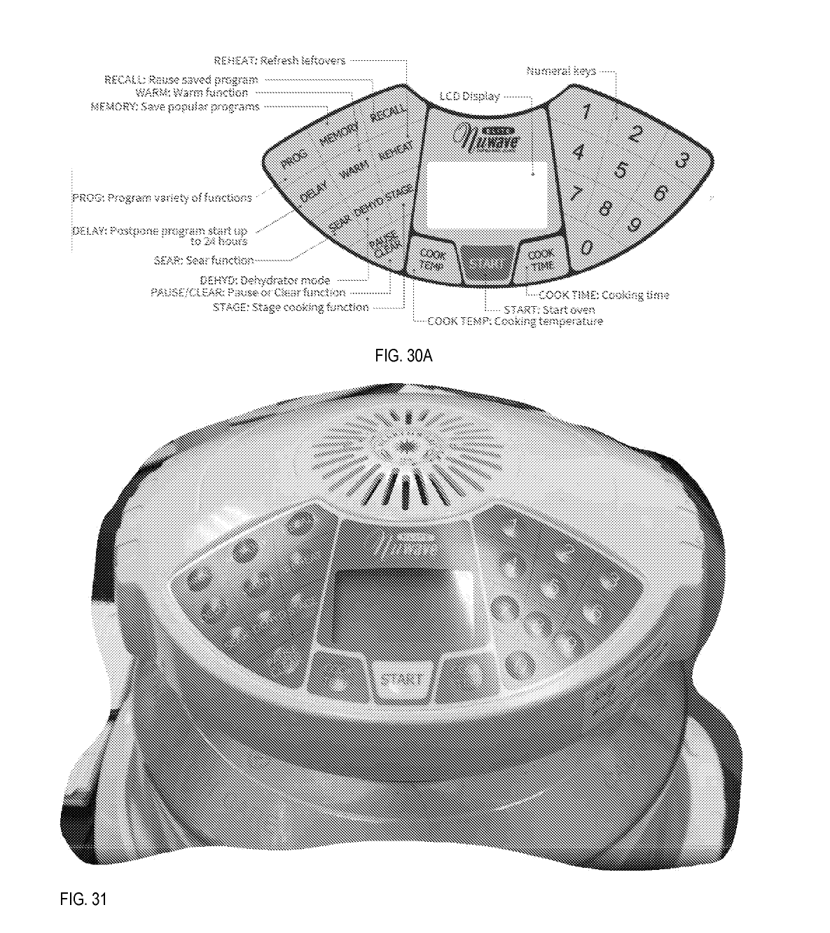

FIG. 30B depicts one exemplary embodiment of a user interface for a countertop oven illustrating various exemplary features and functions, which may include, according to an exemplary embodiment, LCD display, numeric keys, COOK TIME button, START button, COOK TEMP button, PROG button, STAGE button, DEHYD button, PAUSE/CLEAR button, START TIME button, CLOCK button, SEAR button, END TIME, AM/PM button, WARM button, and/or STAGE button, according to another exemplary embodiment;

FIG. 30C depicts one exemplary embodiment of a user interface for a countertop oven illustrating various exemplary features and functions, which may include, according to an exemplary embodiment, LCD display, numeric keys, COOK TIME button, START button, COOK TEMP button, PROG button, DELAY button, SEAR button, PAUSE/CLEAR button, MEMORY button, WARM button, DEHYD (dehydrator mode) button, RECALL button, REHEAT button, and/or STAGE button; According to an exemplary embodiment, as compared to FIG. 30A,—DELAY, MEMORY, RECALL and REHEAT button (functions) have been eliminated in one exemplary embodiment, and exemplary START TIME, END TIME, CLOCK and AM/PM buttons (functions) may be added, according to various exemplary embodiments;

FIG. 34 depicts an exemplary embodiment of an alternative user interface for a countertop oven illustrating various exemplary features and functions, which may include, according to an exemplary embodiment, a smaller LCD display, numeric keys, COOK TIME button, START button, COOK TEMP button, DELAY button, PAUSE/CLEAR button, WARM button, and/or REHEAT button, according to another exemplary embodiment;

FIG. 35 illustrates an exemplary example illustration of a multistage recipe, which may be stored in memory locations 1 through 99, according to an exemplary embodiment, and each memo 1, and memo 2 also illustrated, may also include various stages, up to an architecturally set maximum number of stages, wherein each stage may have a temperature level, represented graphically by a vertical axis, and a temporal duration, i.e. a time period for an exemplary stage, as represented by a horizontal displacement in the illustration, according to another exemplary embodiment;

FIG. 36 depicts an exemplary embodiment of an exemplary alternative base with an exemplary stainless steel pan, and exemplary rack, according to an exemplary embodiment;

FIG. 37 depicts an exemplary top view of an embodiment of an exemplary stainless steel pan having various concentric exemplary rings on the pan's bottom surface, according to an exemplary embodiment;

FIG. 38 depicts an exemplary isometric view of an embodiment of an exemplary stainless steel pan illustrating an exemplary lipped edge of the pan, according to an exemplary embodiment;

FIG. 39 depicts an exemplary isometric view of an embodiment of an exemplary stainless steel pan with an exemplary two level wire rack placed within the pan, according to an exemplary embodiment;

FIG. 40 depicts an exemplary bottom edge view of an embodiment of an exemplary powerhead portion of an exemplary countertop oven, illustrating a plurality of exemplary venting holes, according to an exemplary embodiment;

FIG. 41 depicts an exemplary embodiment of the exemplary alternative base of FIG. 36 illustrating the base with the exemplary stainless steel pan removed therefrom, illustrating a plurality of exemplary feet further illustrated in FIG. 43 on which the pan may rest, as well as at least one silicon foot blown up in FIG. 42, near the center of the upper surface of the exemplary lower plastic base, also illustrating exemplary arc shaped guard portions to avoid injury from coming in contact with the pan, during heating, according to an exemplary embodiment;

FIG. 42 illustrates an exemplary foot with an exemplary silicone surface, according to an exemplary embodiment;

FIG. 43 illustrates an exemplary foot with exemplary horizontal and vertical support, according to an exemplary embodiment;

FIG. 44 illustrates an exemplary view of a gap between the edge of the pan and the edge of the base, according to an exemplary embodiment;

FIG. 45 illustrates an exemplary protective band, according to an exemplary embodiment;

FIG. 46 illustrates how the exemplary protective bands may prevent contact with the lip of the pan, according to an exemplary embodiment;

FIGS. 47 and 48 illustrate how the two handles on either side of the base may be used to lift and/or carry the base with the pan, which may be used as a serving tray, according to an exemplary embodiment;

FIG. 49 illustrates how the dome may be placed on the pan's lip within the protective bands, according to an exemplary embodiment;

FIG. 50 is a bottom view illustrating the bottom of the base with example feet, according to an exemplary embodiment;

FIG. 51 is an isometric view illustrating the bottom feet of the base, and illustrates an underside of an exemplary handle, according to an exemplary embodiment;

FIG. 52 illustrates an exemplary pan on top of a rack, according to an exemplary embodiment;

FIG. 53 illustrates an exemplary dome placed on top of the base, with an exemplary power head attached to the exemplary dome, in an exemplary stored position while the pan is being cleaned, supported on a ledge portion of the base, according to an exemplary embodiment;

FIG. 54 depicts an isometric view of a complete countertop oven with powerhead, dome, stainless steel pan, rack, and base, according to an exemplary embodiment;

FIG. 55 depicts a front view of the complete countertop oven with powerhead, dome, stainless steel pan, rack, and base, according to an exemplary embodiment;

FIGS. 56 and 57 depict an exemplary powerhead illustrating an exemplary safety switch for use with the dehydrator, and may be used to sense whether the power head is atop the dome or dehydrator dome, according to an exemplary embodiment;

FIG. 58 illustrates an exemplary powerhead atop an exemplary dehydrator dome and a stack of a plurality of exemplary trays, according to an exemplary embodiment;

FIG. 59 illustrates alternative air outlets in another alternative powerhead, according to an exemplary embodiment;

FIG. 60 illustrates an exemplary handle of the exemplary power head, according to an exemplary embodiment;

FIG. 61 depicts an exemplary embodiment of various exemplary stainless steel extender rings, according to an exemplary embodiment;

FIG. 62 depicts an exemplary embodiment of an exemplary powerhead and dome atop an exemplary stainless steel extender ring atop the stainless steel pan, according to an exemplary embodiment;

FIG. 63 depicts an exemplary embodiment of an exemplary powerhead and dome atop an exemplary pair of stainless steel extender rings atop the stainless steel pan, according to an exemplary embodiment;

FIG. 64 depicts an exemplary top view of an embodiment of an exemplary upper portion opening of an exemplary dehydrator dome, through which the powerhead may be inserted, according to an exemplary embodiment;

FIG. 65 depicts an exemplary isometric view of an embodiment of an exemplary upper portion atop four exemplary dehydrator trays, and illustrating an exemplary toothed opening of an exemplary dehydrator dome, through which the powerhead may be inserted, and illustrating an exemplary edge for interacting with the exemplary powerhead, according to an exemplary embodiment;

FIG. 66 depicts an exemplary top view of an embodiment of an exemplary dehydrator trays, illustrating exemplary openings through which air may flow for dehydrating foodstuffs placed on an exemplary tray/rack, as well as including exemplary openings in a horizontal surface, and toothed openings in a center cylindrical vertical portion for receiving locking portions from a bottom portion of another dehydrator tray as illustrated in FIG. 67, according to an exemplary embodiment;

FIG. 67 illustrates an exemplary bottom view of an exemplary dehydrator tray illustrating exemplary locking portions for interlocking with a corresponding opening in a top portion of another dehydrator tray, as shown in FIG. 66, according to an exemplary embodiment;

FIG. 68 illustrates an exemplary dehydrator base with exemplary opening in a top surface for receiving a locking mechanism from the bottom portion of a respective dehydrator tray as illustrated above in FIG. 67, according to an exemplary embodiment;

FIG. 69 illustrates an exemplary handle of the base of FIG. 68, according to an exemplary embodiment;

FIG. 70 illustrates an exemplary top cover dome portion of an exemplary dehydrator, according to an exemplary embodiment;

FIG. 71 illustrates placing a powerhead on the exemplary top cover dome portion of FIG. 70, and illustrates the button, which may be used to allow the exemplary powerhead to know that the powerhead has been placed on the dehydrator and to initiate the dehydrator operation of the powerhead automatically, according to an exemplary embodiment;

FIG. 72 illustrates the powerhead inserted into the circular opening of the top cover dome portion, and showing the dehydrator sensor button depressed, as shown in the blowup of FIG. 73, according to an exemplary embodiment;

FIG. 73 illustrates the dehydrator sensor button being depressed by a portion of the dehydrator top cover dome portion, according to an exemplary embodiment;

FIGS. 74 and 75 depict various exemplary openings allowing for airflow through the base of the exemplary dehydrator base, according to an exemplary embodiment;

FIG. 76 depicts two alternative white and black color schemes, according to an exemplary embodiment;

FIG. 77 depicts various exemplary cooking modes, according to an exemplary embodiment;

FIG. 78 depicts an exemplary extender ring kit, bundling an exemplary pan, cooking rack, and/or stainless steel extender ring, according to an exemplary embodiment;

FIG. 79 depicts an exemplary embodiment of an exemplary baking kit as may include an exemplary silicone tray, with exemplary silicone divider as may be used to cook two different exemplary cakes and/or breads, or the like, and may be used to remove the exemplary foodstuff from the tray, an exemplary circular silicone baking ring, exemplary cupcake liners; exemplary whisk, and an exemplary cookbook, according to an exemplary embodiment;

FIG. 80 depicts an exemplary dehydrator kit, according to an exemplary embodiment, including an exemplary top cover dome portion (also referred to as an adapter, a plurality of dehydrator trays, and/or an exemplary dehydrator base as discussed above, according to an exemplary embodiment;

FIG. 81 depicts an exemplary steel extender ring and exemplary roasting stand kit, according to an exemplary embodiment;

FIG. 82 depicts an exemplary pizza kit including an exemplary pizza flipper, server/cutter, a circular shaped silicone pizza liner, and/or an exemplary circular cutting board, according to an exemplary embodiment;

FIG. 83 depicts an exemplary embodiment of an exemplary lightweight, oven carrying case, according to an exemplary embodiment; and

FIG. 84 depicts an exemplary embodiment of an exemplary combined kit of an exemplary oven and related cookbooks, CD, mixers, pizza flipper, and baking pans, according to an exemplary embodiment.

### DETAILED DESCRIPTION OF EXEMPLARY EMBODIMENTS OF THE PRESENT INVENTION

A preferred and various other exemplary embodiments of the invention are discussed in detail below. While specific exemplary embodiments are discussed, it should be understood that this is done for illustration purposes only. A person skilled in the relevant art will recognize that other components and configurations can be used without parting from the spirit and scope of the invention.

An exemplary counter-top electric oven is described herein with reference to the accompanying drawings in accordance to an exemplary embodiment of the invention. However, it should be understood that many features of the invention may find utility in other types of counter-top electric cooking ovens, including those using cyclonic air flow in combination with simple resistance electric heating elements. Accordingly, no limitation is intended to use in connection with an infrared heating element except insofar as expressly stated in the appended claims.

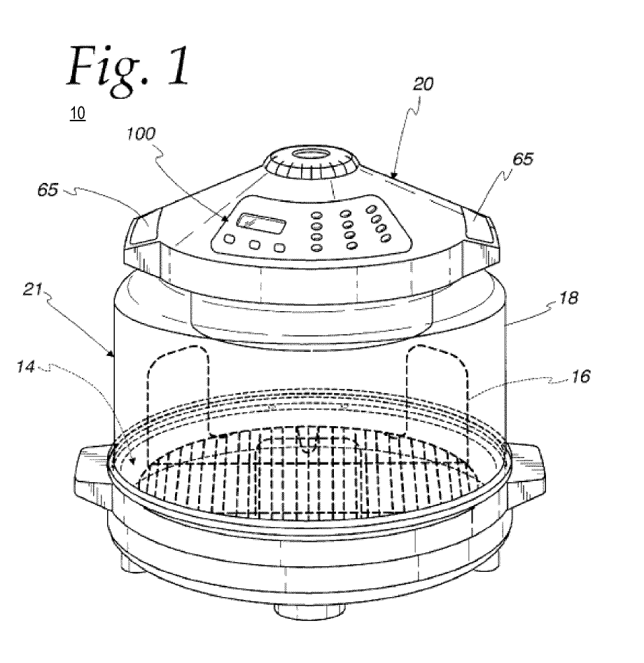

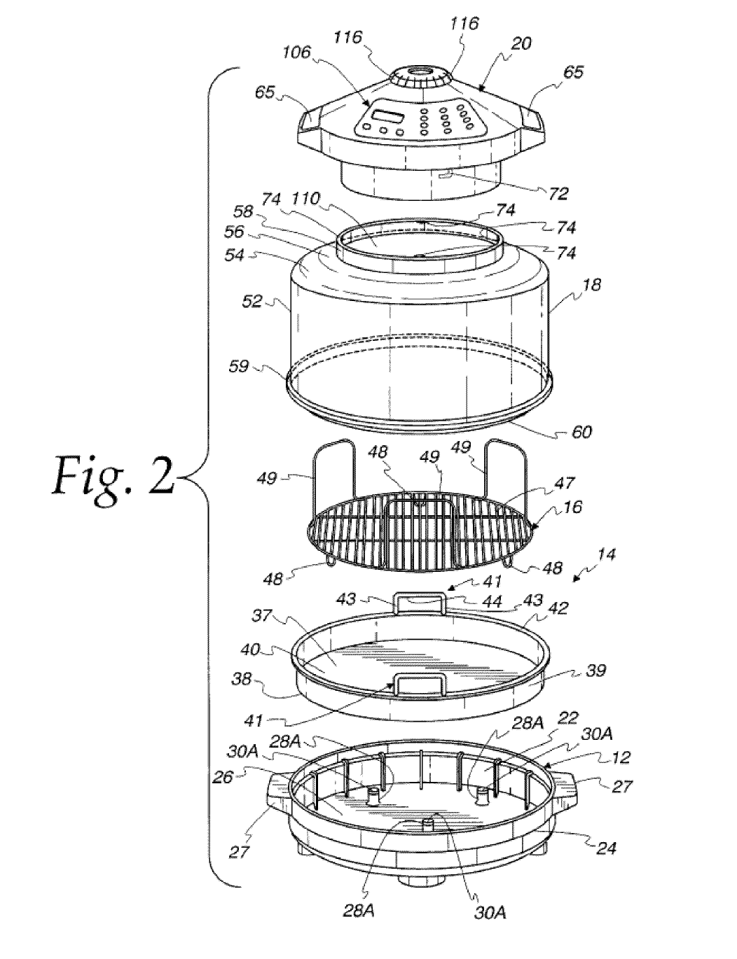

Referring to FIGS. 1 and 2, an exemplary embodiment of a counter-top electric oven 10 may include a base 12, an oven pan 14 supported by the base 12, a cooking rack 16 supported by the oven pan 14, an oven housing 18, which may be cylindrical and transparent and may be supported by the base 12, and a power head 20 with handles 65 supported on the oven housing 18 and may be detachably connected to the oven 10. Together, the oven pan and the oven housing 18 may define an exemplary cooking enclosure 21 with the oven 10 as in the assembled state shown in FIG. 1.

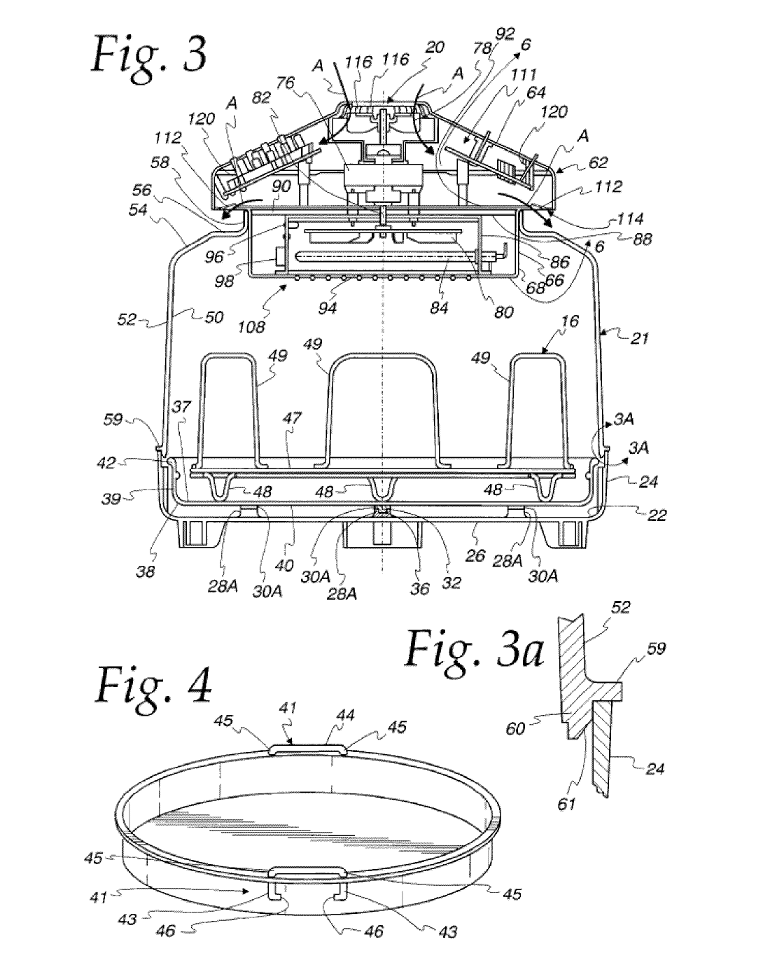

According to an exemplary embodiment of the invention, as shown in FIGS. 2 and 3, the base 12 may have an interior surface 22 defined by a generally cylindrical side wall 24 and a planar bottom 26. In an exemplary embodiment, a pair of handles 27 may extend from the cylindrical side wall 24 to allow a user to move the oven from one location to another. According to an exemplary embodiment, the interior surface 22 may surround the oven pan 14 and may be spaced from the oven pan 14 by an air gap. The base 12 may further include one or more supports 28A, 28B, 28C (collectively 28) for the oven pan 14 and one or more thermal insulators 30 between the one or more supports 28 and the oven pan 14 to prevent overheating of the base 12 by the heat from the oven pan 14. In an exemplary embodiment shown in FIGS. 2 and 3, the one or more supports 28 may be provided in the form of three cylindrical pillars 28A, and the one or more thermal insulating spacers 30 may be provided in the form of three cylindrical spacers 30A, each supported by one of the pillars 28A. As seen in the section view of the spacer 30A and pillar 28A in FIG. 3, each of the spacers 30A, 30B, 30C (collectively 30) may include a cylindrical stub 32 that is engaged in a mating hole 36 in each pillar 28A to retain each of the spacers 30A to the respective pillar 28A. While the cross-sections of the spacers 30A and the pillars 28A may be generally circular, non-circular cross-sections, such as, e.g., but not limited to, triangular, oval, square, rectangular, trapezoidal, hexagonal, etc., may also be contemplated according to embodiments of the invention. According to an exemplary embodiment, the oven pan 14 may be supported on the insulators 30 to maintain the air gap between the interior surface 22 and the cooking pan 14 and to prevent overheating of the base 12, including the handles 27. In an exemplary embodiment, the plastic base 12 may be made from a polycarbonate material and the thermal insulators 30 may be made from a silicone rubber insulating material.

In an exemplary embodiment, the metallic oven pan 14 may include an interior surface 37 and an exterior surface 38 defined by a cylindrical side wall 39 and a planar bottom 40. According to an exemplary embodiment, the oven pan 14 may be a one piece construction made of aluminum plate with a nonstick polytetrafluoroethylene (PTFE) coating on the interior surface 37. According to an exemplary embodiment, a pair of retractable handles 41 may be mounted to a lip 42 that defines an outer periphery of the oven pan 14. The handles 41 may be mounted to the lip 42 for movement between a first position, shown in FIG. 2, where the handles 41 are extended from the lip 42 so that a user may grasp the handles 41 to remove the pan 14 from the base 12, and a second position, shown in FIG. 4, where the handles 41 are retracted toward lip 42 to allow the oven housing 18 to be positioned above the oven pan 14, as shown in FIG. 3, without interfering with the handles 41. In an exemplary embodiment as shown in FIG. 4, each of the handles 41 may have a pair of legs 43 extending from a grasping member 44. In an exemplary embodiment, each of the legs 43 may be received in a vertical guide hole 45 formed in the lip 42 to guide the handles 41 between the first and second positions. Each of the legs may terminate in a tab 46 that engages the lip 42 with the handle 41 in the first position. According to an exemplary embodiment, the handles may be made from a unitary piece of metallic wire that is bent to form the grasping member, the legs 43, and the tabs 46.

According to an exemplary embodiment, the cooking rack 16 may include a planar grid 47 for supporting objects that are being cooked, a first set of loop projections 48 extending in one direction from the plane of the grid 47 and a second set of loop projections 49 extending in the opposite direction from the plane of the grid 47. In an exemplary embodiment, the projections 48 may be used to support the grid to provide a first cooking height for objects supported by the grid 47, while the projections 49 may be used to support the grid 47 to provide a second cooking height for the grid 47. According to an exemplary embodiment, the cooking rack 16 may be made from Grade 304 stainless steel with a non-stick PTFE coating.

In the embodiment as shown in FIG. 3, an exemplary embodiment of an oven housing 18 may include an interior surface 50 defined by a generally cylindrical side wall 52 that blends into a generally conical shaped side wall 54 which in turn blends into a planar upper wall 56 which finally blends into a generally cylindrical ring 58. An annular lip 59 may be formed on the outer surface of the wall 52 and serves to support the oven housing 18 on the side wall 24 of the base 12. A portion 60 of the wall 52 may extend below the lip 59 and may cooperate with the side wall 24 of the base 12 to restrict the leakage of hot gases, such as steam, from the cooking enclosure 21. In the embodiment as shown in FIG. 3A, the portion 60 may include an annular lead-in chamfer or relief 61 that serves to guide the portion 60 into the base 12, thereby easing the engagement of the oven housing 18 to the base 12 and preventing the mislocation of the housing 18 relative to the base 12. According to an exemplary embodiment, the oven housing 18 may be formed from a transparent polycarbonate material. The relief 61 may allow for the portion 60 to be flexibly inserted into the base 12 without precise vertical movement of the housing 18 relative to the base 12, such that the housing 18 can be inserted into the base 12 without having a perfect perpendicular angle relative to the base 12.

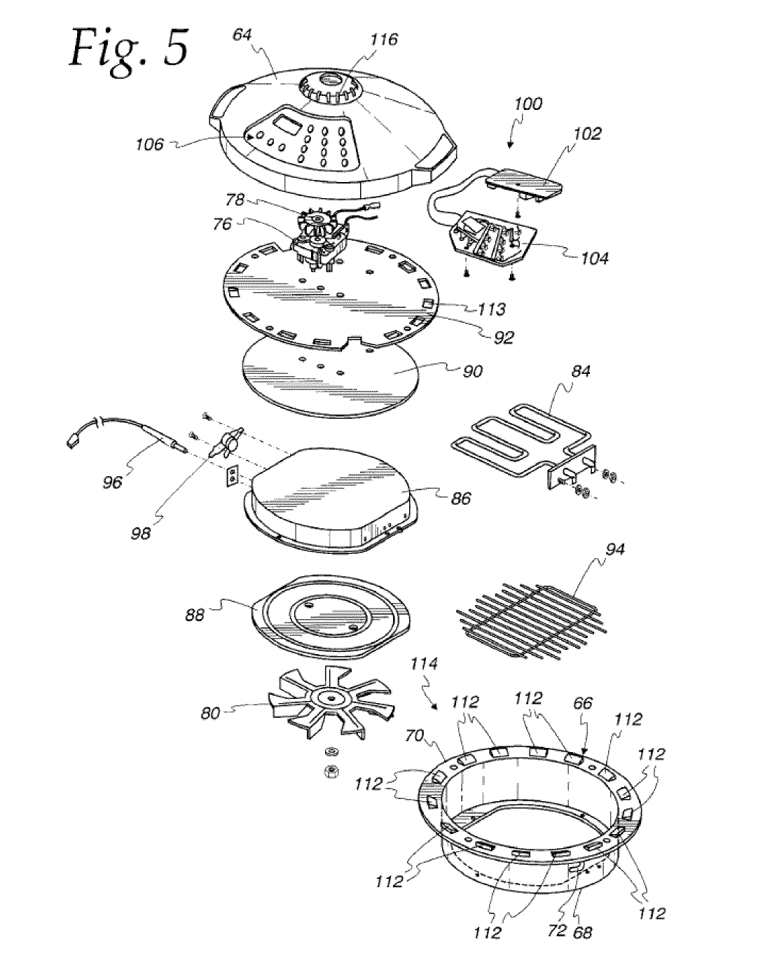

In the embodiment as shown in FIGS. 3 and 5, the power head 20 may include exterior housing assembly 62. According to an exemplary embodiment, the assembly 62 may include a domed shape upper housing 64 having a pair of handles, and a lower housing 66 including a cylindrical wall portion and an annular flange 70. As seen in FIG. 2, according to an exemplary embodiment, four equally spaced lands 72 (only one shown) may be raised from the cylindrical wall 66 to engage a plurality of ramped tabs 74 formed on the ring 58 of the housing 18 to detachably connect the power head 20 and the housing 18. The power head 20 may further include a motor 76 for driving a cooling fan 78 and an oven fan 80 via a common shaft 82, an infrared electric heating element 84, a heater/fan housing 86, a radiation plate 88 mounted to an interior surface of the heater housing 86, a glass fiber thermal insulator 90 mounted between the heater housing 86 and the motor 76, a mica sheet 92 mounted between the upper housing 64 and the lower housing 66, a protective grid 94, a thermistor 96, a thermostat 98, and a control system 100 including a pair of control boards 102 and 104 for controlling the heating element 84 and the motor 76 in response to signals from the thermistor 96 and command signals input from an input interface 106 by a user. According to an exemplary embodiment, the fan 78 may be made of a plastic material, while the fan 80 and the radiation plate 88 may be made of aluminum plate in order to reflect the infrared energy from the heater 84 down toward the interior of the cooking enclosure 21. According to an exemplary embodiment, the motor 76 may drive the fans 78 and 80 at a speed in the range of 2500 rpm, which should provide an adequate air flow from the fan 80 to create a relatively even temperature throughout the cooking enclosure 21 and to speed the cooking of food by convection to supplement the infrared cooking, without generating the high speed air motion associated with some cyclonic electric counter-top ovens. The relatively low speed air flow created by the fan 80 may also provide another benefit in that it may help to maintain the hot surfaces of the oven 10 in a temperature range that may tend to emit infrared radiation and limit the reduction in emissivity of the non-metal materials of the oven 10. In an exemplary embodiment, the heating element 84 may be made of an incoloy 840 material coated with a G-1500 (CRC 1500) ceramic coating having a coating thickness of 20.+−.5 μm, with the main components of the coating material being SiO₂, TiO₂, and Al₂O₃, with an inorganic pigment, mainly Si—O. The ceramic coating may increase the emissive power of the heating element and shift the emission spectrum to the infrared range. With this coating, the heating element 84 may be capable of generating approximately 98% or more of its heat radiation in the infrared range. A sol-gel coating method may be used for coating the ceramic material firmly onto the incoloy 840 material. Infrared electric heating elements of this construction have been used in the past on hair dryers, bread makers, etc. The grid 94 may be made of 304 stainless steel or from a PTFE coated metallic material. According to an exemplary embodiment, the upper housing 64 may be made from a polycarbonate material and the lower housing and the heater housing may be made from zinc plated steel or steel coated with a non-stick PTFE coating.

Together, the cylindrical wall portion 68 of the lower housing 66, the heater housing 86, the radiation plate 88, the fan 80, and the heating element 84 may define an exemplary heating unit 108 that may extend into the cooking enclosure 21 through an opening 110 defined by the cylindrical portion 58 of the housing 18. Together, the upper housing 64 and the mica sheet 92 may define an exemplary fan chamber 111 that may be thermally insulated from the interior of the cooking enclosure 21 by the mica sheet 92, the glass fiber insulator 90, the heater housing 86, the radiation plate 88, and the lower housing 66. In an exemplary embodiment as shown in FIGS. 3 and 5, a plurality of cooling air outlets 112 may form in the annular flange 70 of the lower housing 66. Cut-outs 113 may be provided in the mica sheet 92 to prevent interference between the outlets 112 and the mica sheet 92 and to allow a cooling air flow to pass through the mica sheet 92 to the outlets 112. The outlets 112 may be equally circumferentially spaced around the flange 70.

Together the flange 70 and the outlets 112 may define an exemplary cooling manifold 114 that surrounds the opening 110 of the housing 18 and faces the surface 56 outside of the cooking enclosure 21. The cooling fan 78 may actively cool the fan chamber 111 and the walls 52, 54, 56 and 58 of the housing 18 by drawing a cooling air flow through a plurality of inlet openings 116 formed in the upper housing 64 and forcing the cooling air to exit through the outlets 112, which direct the cooling air flow toward the surface 56 of the housing 18 to cool the housing 18, as indicated by arrows A.

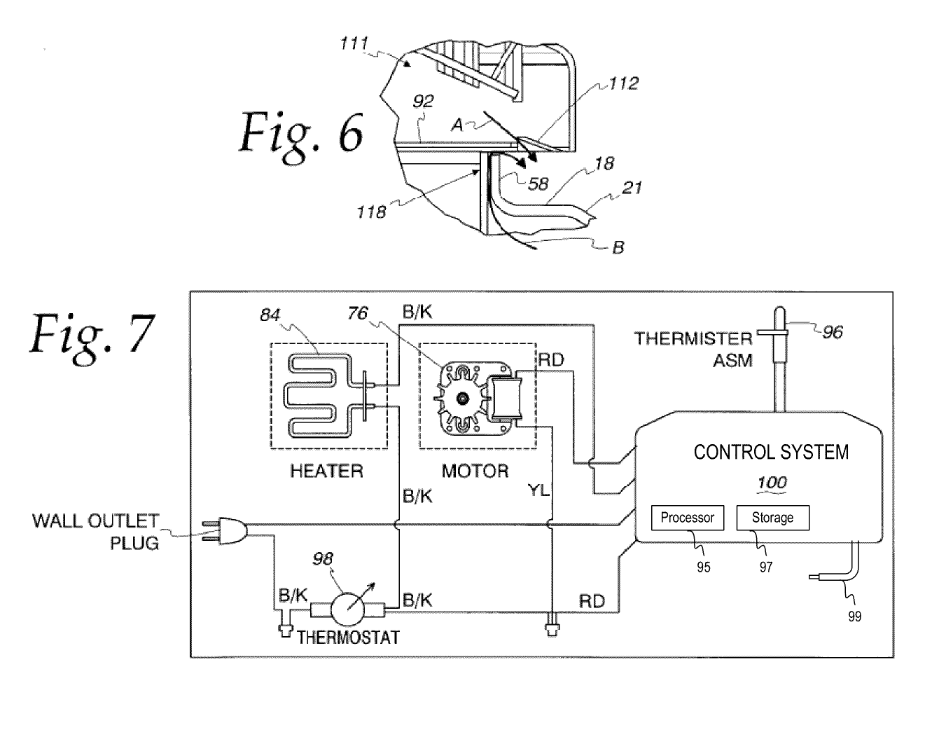

In the embodiment as shown in FIG. 6, the wall 68 and the flange 70 may be spaced from the cylindrical ring 58 of the housing 18 by the tabs 74 to define an exemplary hot gas vent 118 that surrounds the heating unit 108 between the heating unit 108 and the outlets 112 to vent hot gas, such as steam, from the inside of the cooking enclosure 21 for mixture with the cooling air flow from the air outlets 112, as shown by the arrow B.

According to an exemplary embodiment, the control boards 102 and 104 may be spaced from the interior surface of the upper housing 64 by a plurality of mount supports 120 to allow the cooling air flow to pass over both sides of the control boards 102 and 104 as it circulates around the fan chamber 111 before exiting through the outlets 112, thereby enhancing the cooling of the electronics on the control boards 102 and 104.

In an exemplary embodiment as shown in FIG. 7, the control system 100 may be coupled to the motor 76 and the heating element 84 to control the flow of electric power to the motor 76 and to one or more heating elements 84 in response to signals from the thermostat 98 and command signal input from the input interface 106 by a user (not shown). According to an exemplary embodiment, the control system 100 may be configured to selectively power the heating element 84 at a number of power levels P from a minimum power to a maximum power. At each power increment P, the control system 100 may power the heating element(s) 84 when the thermistor 96 indicates that the temperature in the cooking enclosure 21 has fallen below a low temperature set point associated with the particular power level P. The control system 100 then may terminate power to the heating element 84 when the temperature indicated by the thermistor 96 exceeds a high temperature set point associated with the particular power level P. The control system may provide power continuously to the motor 76 during the heating operations regardless of the power level selected. According to one exemplary embodiment, a multi-stage cooking recipe may be input, processed, stored, accessed, executed and/or deleted by the control system 100.

According to an exemplary embodiment, the control system 100 may heat the oven to a temperature determined by a power level. The control system 100 may support one or more power levels. Each power level may represent a target temperature to heat the oven to. In an exemplary embodiment, the control system 100 may have ten different selectable power levels. In an exemplary embodiment, the power levels may correspond to the temperatures 125° F., 150° F., 175° F., 200° F., 225° F., 250° F., 275° F., 300° F., 325° F., and/or 350° F.

In an exemplary embodiment, the oven may be designed to allow vegans and rawgetarians to cook the food to the point where the bacteria are eliminated but, at the same time, not eliminate the vital enzymes. For example, the oven may preserve vital enzymes in vegetables by controlling the temperature of the oven. In one such exemplary embodiment, a power level of the oven may set the desired temperature of the oven to be 106° F., though additional power levels of the oven may be configured to control the temperature of the oven for eliminating bacteria and preserving vital enzymes in food. In an exemplary embodiment, the power levels may correspond to the following temperatures: 106° F., 116° F., 150° F., 175° F., 225° F., 250° F., 275° F., 300° F., 325° F., and/or 350° F.

An exemplary embodiment of the control system 100 may also include a processor 95, and a storage device 97, such as, e.g., but not limited to, a memory, a register, a read-only memory (ROM), a random access memory (RAM), a solid state memory device, a flash memory device, a hard disk drive (HDD), a removable disk device such as, e.g., but not limited to, a CD-ROM, a DVD, etc. According to an exemplary embodiment, command signal input from the input interface 106 (such as, e.g., but not limited to, a keyboard, a keypad, a remote control, a voice activated interface, a voice recognition system, etc.) by a user may be received by the processor 95 and storage device 97 to create a multi-stage cooking recipe that may be further edited or executed. In an exemplary embodiment the multi-stage cooking recipe may be stored in the storage device 97 in the form of volatile memory for temporary storage, nonvolatile memory for permanent storage, or both. During execution the processor 95 may receive input from a variety of sources to determine what and when stages should be executed.

In an exemplary embodiment, the oven may further include a temperature probe 99. In an exemplary embodiment, the temperature probe 99 may be detachable from the oven for, e.g., but not limited to, cleaning, etc. The probe 99 may be physically connected to the oven during use or may be coupled, such as, e.g., but not limited to, through wireless communication, with the oven. In an exemplary embodiment, the temperature probe 99 may be attached to the oven and may or may not be removable from the oven. The temperature probe 99 may be inserted into objects being cooked so that information regarding the interior of the object, such as, e.g., but not limited to, temperature, level of doneness, etc., can be determined. The probe 99 information may be received by the processor 95 and may be used in the multi-stage cooking recipe programming and/or execution.

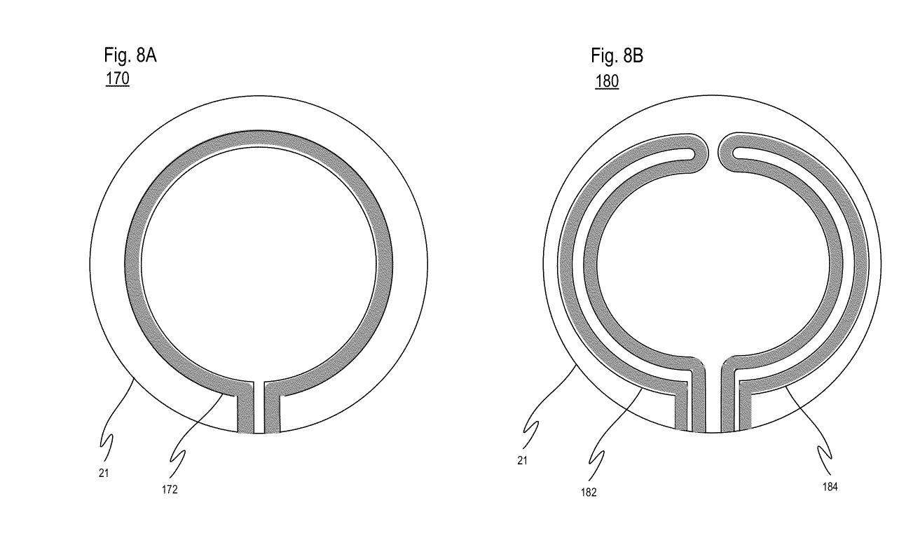

In the exemplary embodiment as shown in FIG. 8B, the oven may include a plurality of heating element 182, 184. The heating element(s) 182, 184 may have a top and bottom configuration, a side to side configuration, or some other configuration. In an exemplary embodiment, the heating elements may have individually selectable power levels, linked selectable power levels, and/or some combination. In an exemplary embodiment, the oven may include heating element(s) 172, 182, 184 on the bottom of the oven. In an exemplary embodiment, the heating element(s) 172, 182, 184 may be arranged such that drippings from the object being cooked do not fall upon the heating element(s) 172, 182, 184, such as, e.g., but not limited to, arranging a heating element 172 in a circular shape 170 around the cooking enclosure 21, as shown in FIG. 8A, or arranging two semi-circular heating elements 182, 184 in a circular shape 180, as shown in FIG. 8B, etc.

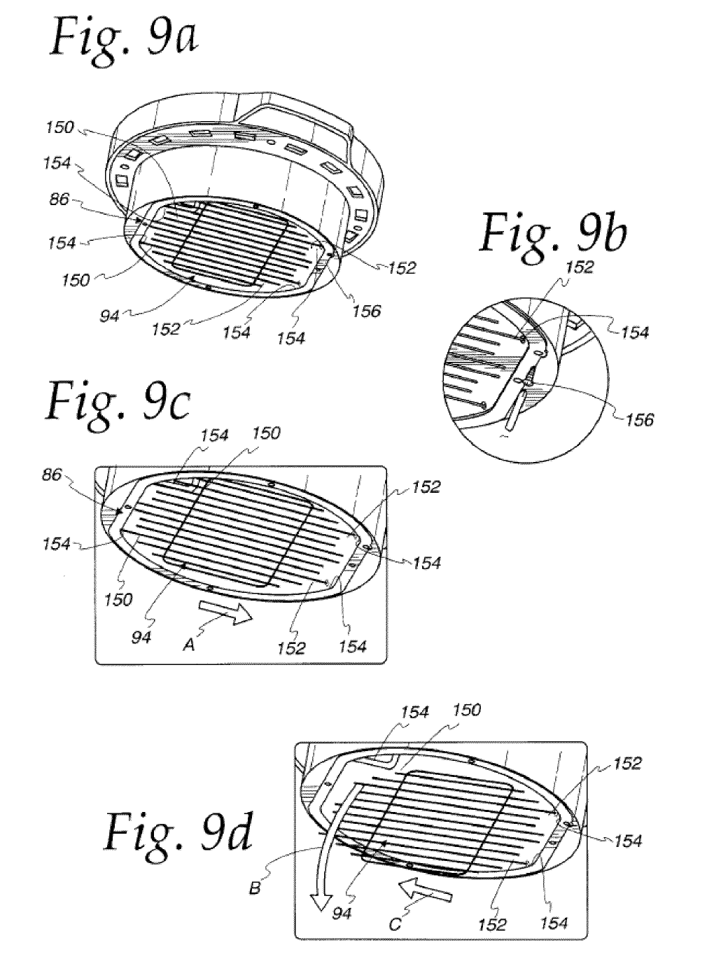

In an exemplary embodiment as shown in FIG. 9a, the protective grid 94 may include a first pair of legs 150 that may be oppositely directed relative to a second pair of legs 152. In an exemplary embodiment as shown in FIG. 9b, each of the exemplary legs 150, 152, may be slideably received in a mating aperture 154 in the heater housing 86 to detachably mount the protective grid 94 to the heater housing 86. A fastener 156 may be engaged with the heater housing 86 for movement between a first position shown in FIG. 9a where the fastener engages one of the legs 152 to restrict movement of the grid 94 relative to the heater housing 86 to prevent removal of the grid 94 from the heater housing 86, and a second position shown in FIG. 9b where the fastener may be disengaged from the one leg 152 to allow removal of the grid 94 from the heater housing 86. In the exemplary embodiment as shown in FIG. 9b, the fastener 156 may be provided in the form of a threaded set screw that is threadably engaged with the housing 86, with the end of the set screw frictionally engaging the one leg 152 in the first position shown in FIG. 9a. In this regard, it should be noted that for the fastener to be in the second position it need not be completely removed from the housing 86 as shown in FIG. 9b, rather, the fastener 156 need only be positioned so that it is disengaged from the one leg 152 to allow movement of the grid 94 relative to the housing 86. In the exemplary embodiment as shown in FIG. 9c, with the exemplary fastener 156 in the second position, the legs 152 may be slid in the apertures 154 to allow the grid 94 to move relative to the housing 86 in the direction of the legs 152, as indicated by Arrow A, to thereby remove the legs 150 from their mating apertures 154. Once the exemplary legs 150 are removed from their mating apertures 154, the grid 94 may be tilted downward as shown by the arrow B in FIG. 9d and then the grid 94 may be moved in the direction of the legs 150, as indicated by Arrow C, to thereby remove the legs 152 from their mating apertures 154 and thus, the grid 94 from the housing 86. Removal of the exemplary grid allows for cleaning of the heating element 84, the fan 80, the reflector plate 88, and the interior of the housing 86.

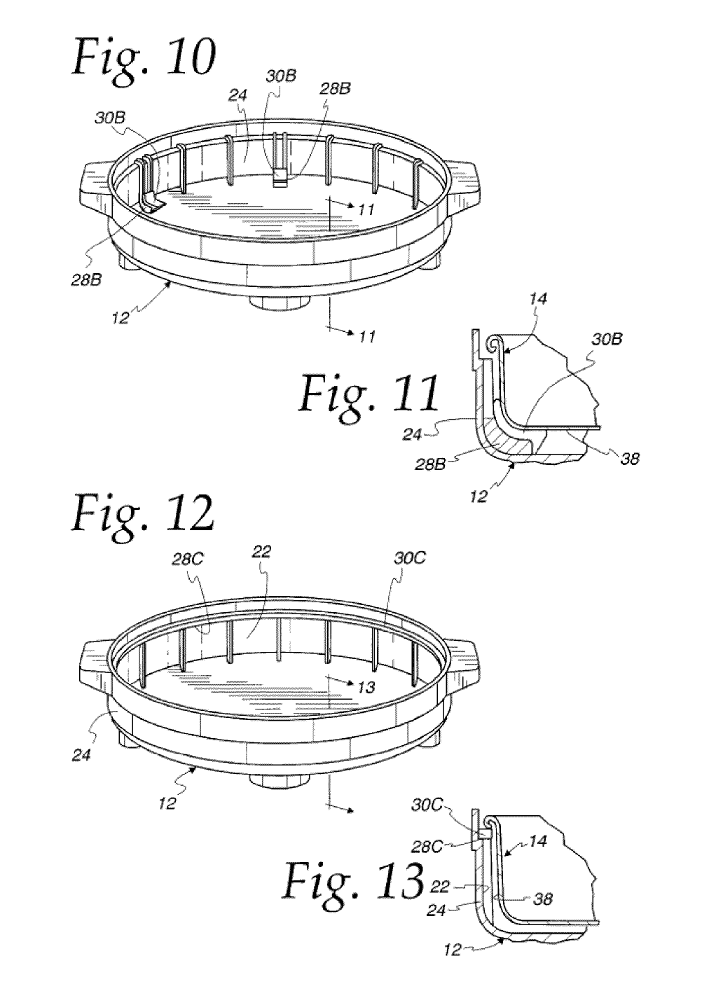

In the exemplary embodiments as shown in FIGS. 10 and 11, in an alternative embodiment of the base 12, the one or more supports 28 may be provided in the form of three or more circumferentially spaced feet 28B that extend from the side wall 24 to underlie the oven pan 14, and the thermal insulators 30 may be provided in the form of three or more thermal insulating spacers 30B, each supported by one of the feet 28B.

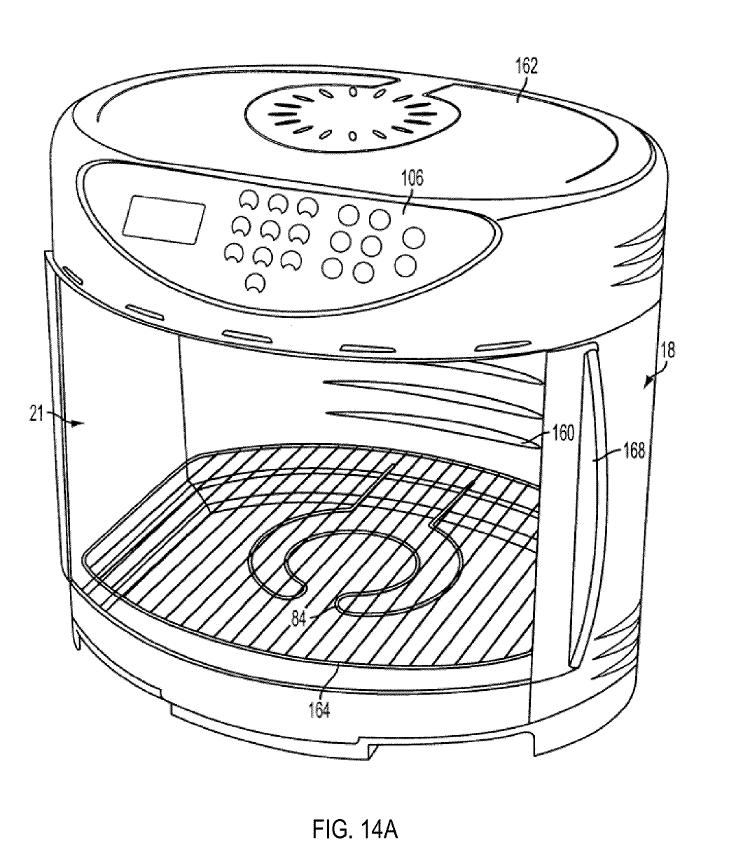

In the exemplary embodiments as shown in FIGS. 12 and 13, in an alternative embodiment of the base 12, the one or more supports 28 may be provided in the form of an annular shoulder 28C formed on the interior surface 22 of the base 12, and the one or more insulators 30 may be provided in the form of a thermal insulating ring 30C that is supported by the shoulder 28C.

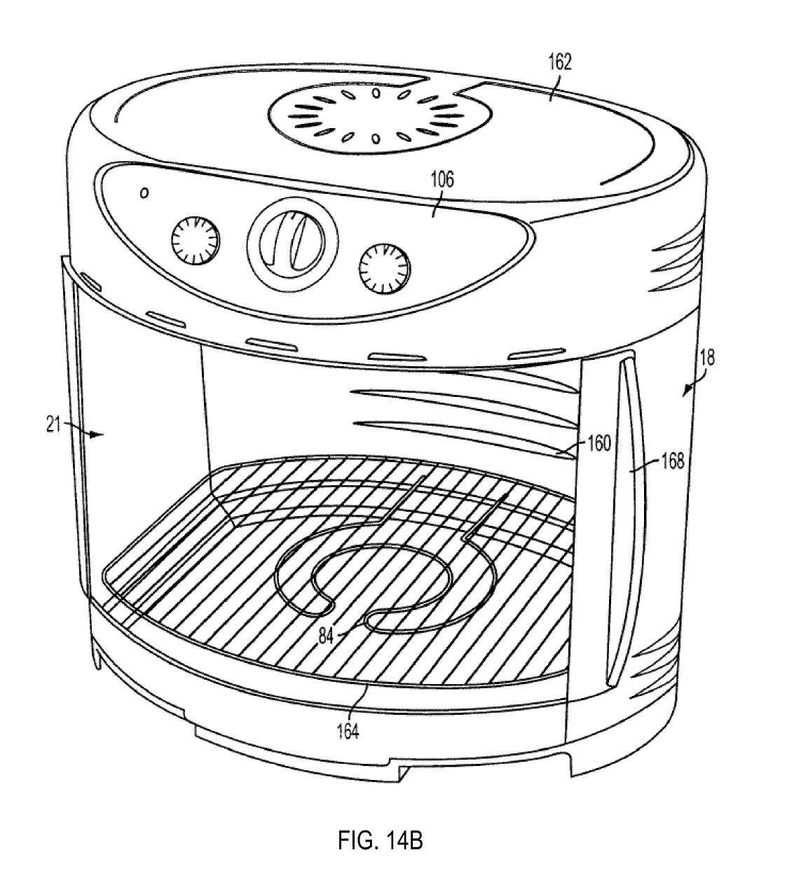

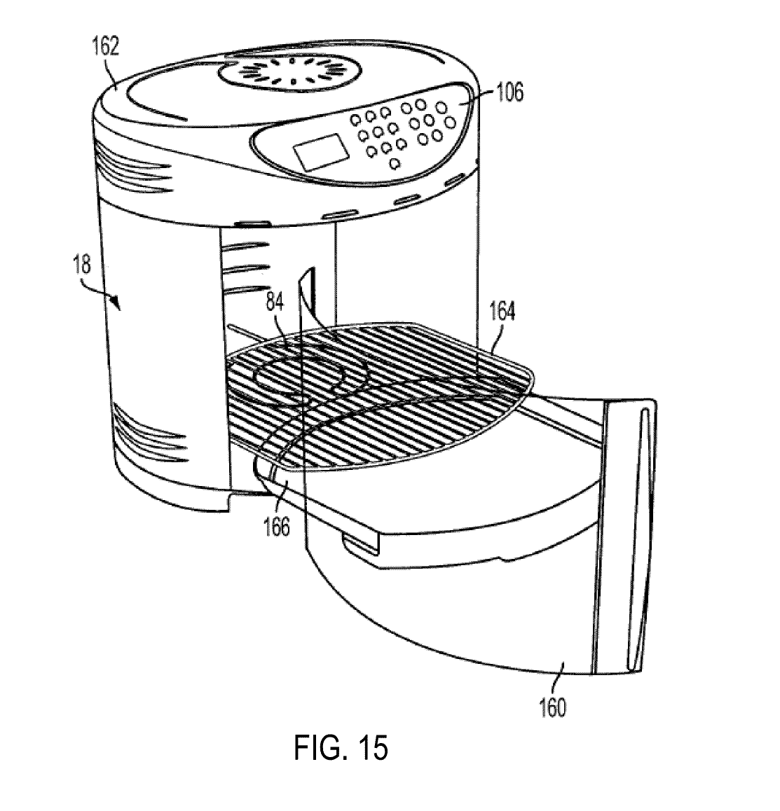

In the exemplary embodiments as shown in the various perspectives of FIGS. 14A, 14B, 15, 16A and 16B, the cooking enclosure 21 may include metal and/or glass such that the oven can sustain a higher maximum temperature than an oven composed of polycarbonate can sustain. According to an exemplary embodiment, the oven may include a digital interface, as shown in FIG. 14A, and/or an analog interface, as shown in FIG. 14B. According to an exemplary embodiment, the cooking enclosure 21 may include a non-detachable power head 162 and/or a hinged and/or sliding glass door 160 that may be opened to insert and remove objects from the oven. In an exemplary embodiment the oven housing 18 may include a groove 168 along the edge of the glass door for grip. In an exemplary embodiment depicts in FIG. 15, the hinged and/or sliding glass door 160 may be detached for easy cleaning In another exemplary embodiment, the cooking enclosure 21 may include a door which is slideable (not shown). In an exemplary embodiment the oven may include a slideably removable cooking rack 164 and a slideably removable oven pan 166. In an exemplary embodiment, the oven can be adapted to receive a rotisserie. According to an exemplary embodiment the oven may include a side or top view which may be, e.g., but not limited to, a circular shape, an oval shape, or any number of other shapes such as, e.g., but not limited to, triangular, square, rectangular, trapezoidal, octagonal, polygonal, pentagonal and/or hexagonal, etc.

In a further embodiment, the oven may also include a small window (not shown) that can be optionally opened to let steam or moisture out of the oven, allowing the food to cook crispier. In an exemplary embodiment, the window may be a small glass door arranged on the glass door 160, though the window may also be arranged elsewhere on the oven. In an exemplary embodiment, the window may be sliding or folding and may be, e.g., but not limited to, 20 mm×50 mm in size. In an alternative embodiment, the window may be a hole plugged in with non-conductive material such as, e.g., but not limited to, silicon rubber, which may be unplugged to let moisture or steam out.

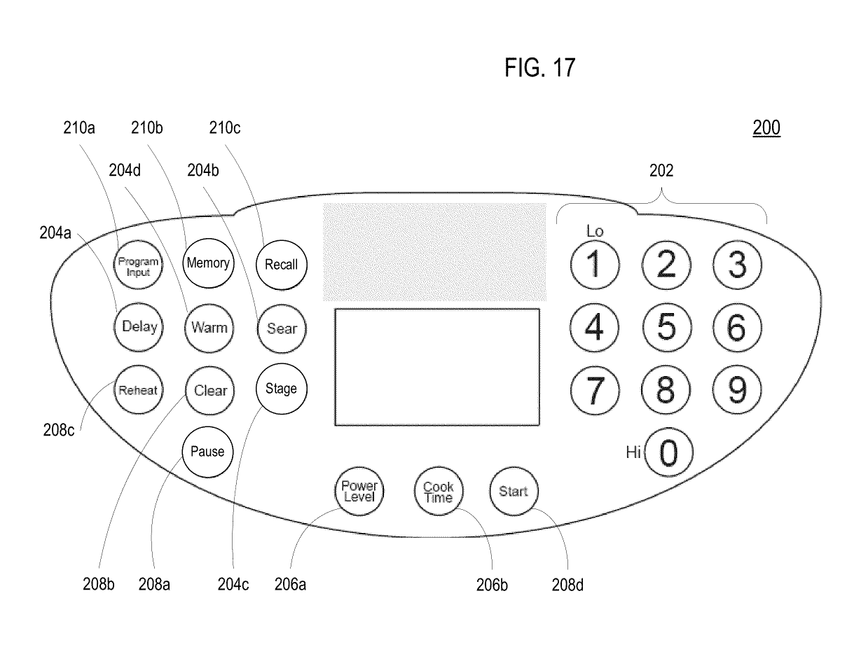

FIG. 17 depicts an exemplary input interface 200 of an exemplary embodiment of a multi-stage cooking electric oven. The input interface 200 may include, e.g., but not limited to, a numeric keypad 202 by which numerical values can be inputted into the oven for values such as, e.g., but not limited to, the power level, time duration of cooking, desired temperature, level of doneness, memory address, etc. Alternatively, a voice recognition and/or other input interface 200 may be included. The input interface 200 may also include control elements corresponding to various stages of a recipe including, e.g., but not limited to, a delay stage 204a, a sear stage 204b, a 204c, and/or a warm stage 204d, etc. The input interface 200 may also include control elements for programming information for each stage including, e.g., but not limited to, power level 206a, cook time 206b, etc. The input interface 200 may also include control elements for commands such as, e.g., but not limited to, pause 208a, clear 208b, reheat 208c, start 208d, etc. The input interface 200 may also include control elements for programming functions such as, e.g., but not limited to, program input 210a, memory 210b, recall 210c, etc.

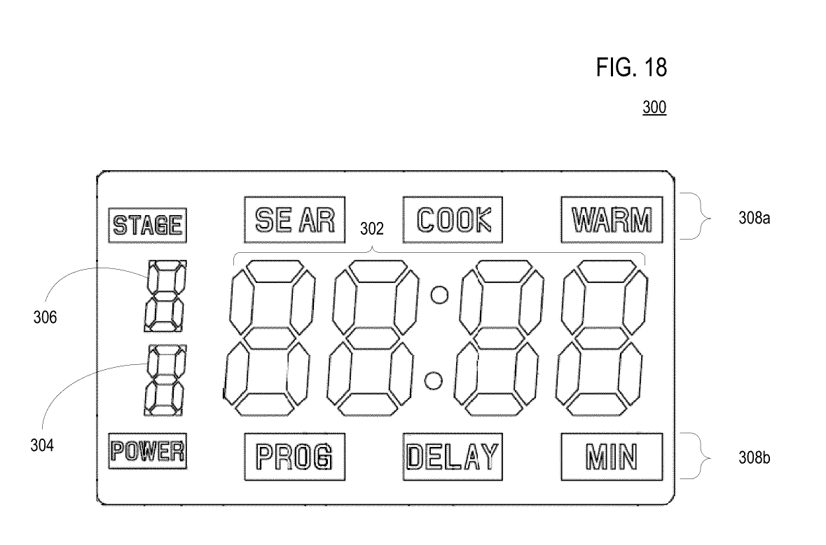

An exemplary display panel 300 of an exemplary embodiment of a multi-stage cooking electric oven is shown in FIG. 18. The exemplary display panel 300 can show multi-stage cooking recipe information such as, e.g. but not limited to, time, power level, and/or stage, etc. The exemplary display panel 300 may include an area in which a numerical value can be displayed, in the exemplary embodiment, comprising of four seven-segment displays 302. The numerical value can represent information regarding, e.g., but not limited to, the duration time, duration of time left, memory address to save and/or load a multi-stage cooking recipe, etc. The exemplary display panel 300 may also include, e.g., but not limited to, a display in which the power level of a stage can be displayed 304. Another display, in the exemplary embodiment may show the stage number 306. The exemplary display panel 300 may also include, e.g., but not limited to, indicators 308a, 308b for each type of stage or type of programming information needed. In the exemplary embodiment, the indicators may represent POWER, PROG, DELAY, MIN, STAGE, SEAR, COOK and/or WARM. In an exemplary embodiment, these indicators may blink when their corresponding information may be entered and may remain lit after their corresponding information is set. According to an exemplary embodiment, during execution these indicators may light up to indicate which stage is being executed and which stages may remain.

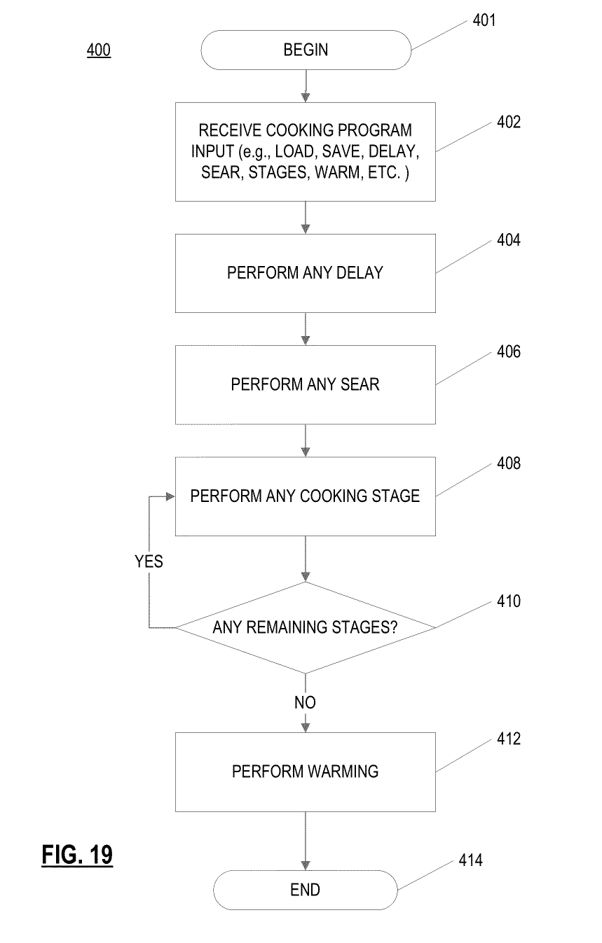

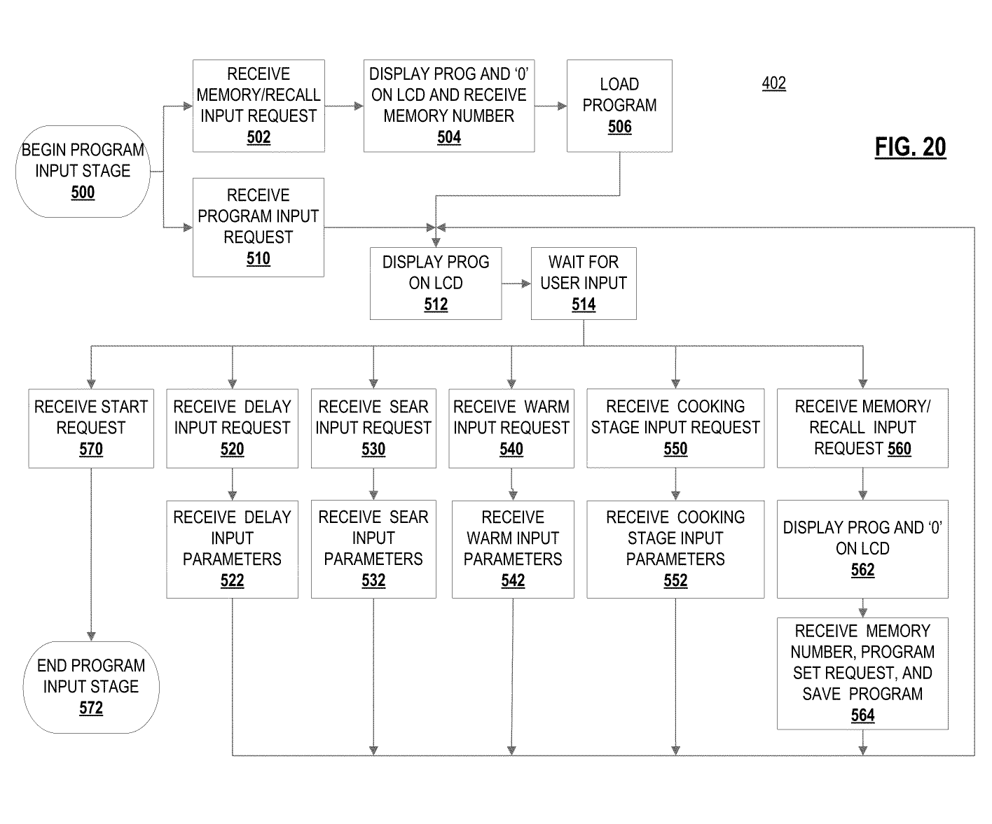

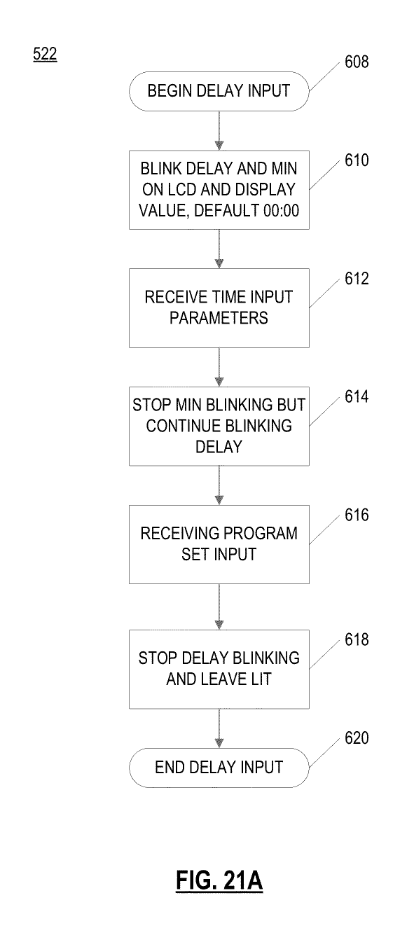

FIG. 19 is an exemplary process flowchart 400 of a basic multi-stage cooking recipe algorithm executable by an exemplary control system of an exemplary counter-top oven, according to an exemplary embodiment of the invention. According to an exemplary embodiment, the process flowchart 400 may begin at 401 and may continue with receiving cooking programming input for a multi-stage cooking recipe from the input interface, 402 (the method described in further detail in FIG. 20-22). After the Start button is depressed, any programmed delay stage may be performed, 404. During the delay stage the microwave may wait for the corresponding programmed duration before beginning cooking in the following stages. At the end of the delay stage the oven may beep to signal the end of the stage. After the delay stage, any sear stage may be performed, 406. The sear stage may heat the oven to a high temperature to sear the food initially for better browning and locking in juices. At the end of the sear stage the oven may beep to signal the end of the stage. After the sear stage any user-defined cooking stages may be performed, 408. In an exemplary embodiment, there may be multiple user-defined cooking stages, e.g., but not limited to, three, four, five, six, etc., cooking stages. In an exemplary embodiment, the initial user-defined cooking stage may be performed by heating the oven according to a specified power level for a duration corresponding to factors such as, e.g., but not limited to, duration of time, desired temperature, level of doneness, etc. After the initial cooking stage, if any user-defined stages remain, each subsequent cooking stage may be sequentially performed, 410. After all cooking stages are completed, the oven may beep four times and then may perform a warm stage, if any, 412. During the warm stage, the oven may heat the food at a low temperature to keep the food warm while it is in the oven. The process flowchart 400 may then end, 414.

An exemplary process of receiving cooking program input 402 is shown in greater detail in FIG. 20, according to an exemplary embodiment of the invention. In an exemplary embodiment, the process 402 may begin at program input stage, 500. In an exemplary embodiment, the program input may occur when the control system may receive a Memory/Recall input request, 502, and/or receive a Program Input request, 510. When a Memory/Recall input request 502 is received, the control system may display “PROG” and ‘0’ on the LCD, and may wait to receive a valid memory number, 504. Upon receiving a memory number, the control system may then load the previously programmed user-entered multi-stage cooking recipe from the corresponding memory address, 506.

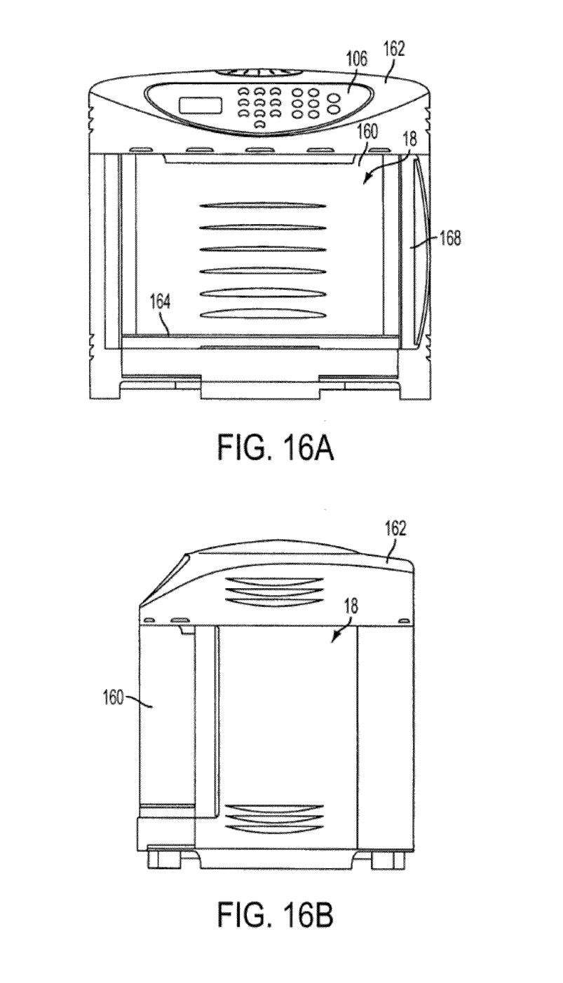

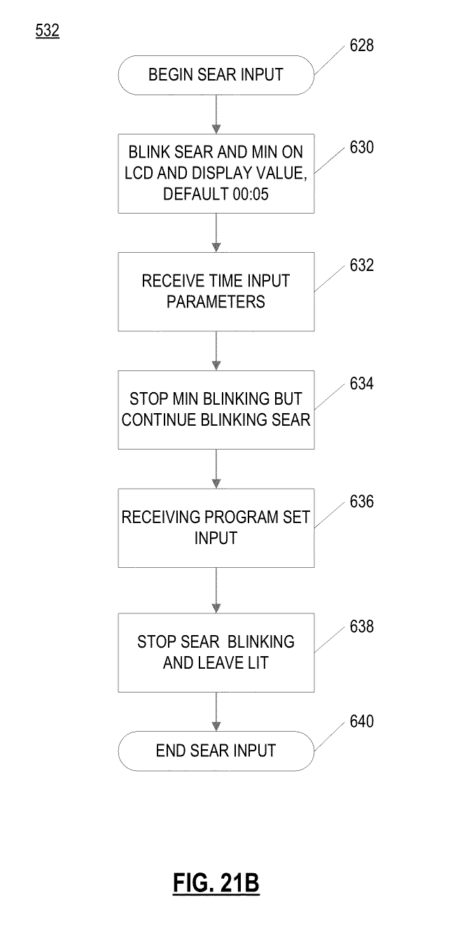

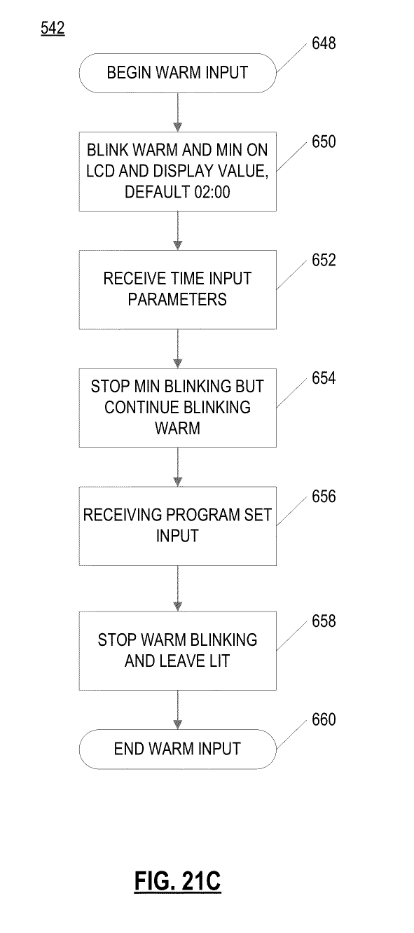

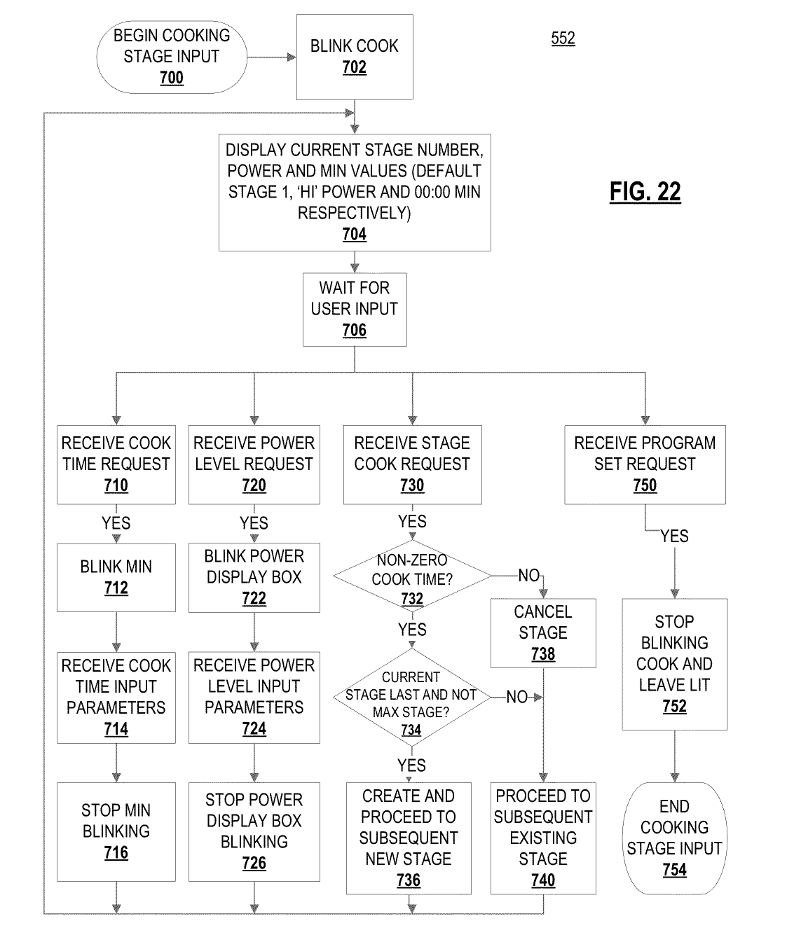

According to an exemplary embodiment, after a program loads, 506, and/or a Program Input request is received, 510, the control system may display “PROG” on the LCD, 512. The control system may then wait for further user input, 514. If the system receives a Delay input request, 520, it may receive the Delay input parameters, 522 (described further in FIG. 21A). If the system receives a Sear input request, 530, it may receive the Sear input parameters, 532 (described further in FIG. 21B). If the system receives a Warm input request, 540, it may receive the Warm input parameters, 542 (described further in FIG. 18C). If the system receives a Cooking Stage input request, 550, it may receive the Cooking Stage input parameters, 552 (described further in FIG. 22). If the system receives a Memory/Recall input request, 560, it may display “PROG” and ‘0’ on the LCD, 562. After the control system receives the memory number and the program set request, it may save the current cooking recipe to the corresponding memory address, 564. In the case where the corresponding memory address already has a previously saved cooking recipe, the previously programmed recipe may be overwritten with the current recipe. After receiving the input in each of the above cases, the control system may then return to display “PROG” on the LCD, 512, and may wait for further user input, 514. When the control system receives a Start request, 570, program input may end, 572, and the control system may begin execution of the recipe as shown in FIG. 16. In an, exemplary embodiment additional programming such as, e.g., but not limited to, editing, adding and/or deleting stages may occur even during execution of the recipe.

Referring now to FIG. 21A, an exemplary process flow 522 of how Delay input parameters may be received is described in further detail. In an exemplary embodiment, as shown in FIG. 20, when an input request is received, 520, Delay input parameters may be received, 522. In an exemplary embodiment, the process flow 522 may start at 608 and may continue, in response to the input request, to blink DELAY and MIN on the LCD and/or display the current time duration value of the delay, 610. If there is no current value, the default value may be 00:00. Upon the control system receiving the time input parameters from user input, 612, MIN may stop blinking, but DELAY may continue to blink, 614. After receiving the Program Set input, 616, DELAY may stop blinking and/or may remain on, 618. From 618, the process flow 522 may then end, 620.

FIG. 21B describes an exemplary process flow 532 of how Sear input parameters may be received, according to an exemplary embodiment of the invention. In an exemplary embodiment, as shown in FIG. 20, when a Sear input request is received, 530, Sear input parameters may be received, 532. In an exemplary embodiment, the process flow 532 may start at 628 and may continue, in response to the input request, to blink SEAR and MIN on the LCD and/or display the current time duration value of the sear, 630. If there is no current value, the default value may be 00:05. Upon the control system receiving the time input parameters from user input, 632, MIN may stop blinking, but SEAR may continue to blink, 634. After receiving the Program Set input, 636, SEAR may stop blinking and may remain on, 638. From 638, the process flow 532 may then end, 640.

FIG. 21C describes an exemplary process flow 542 of how Warm input parameters may be received, according to an exemplary embodiment of the invention. In an exemplary embodiment, as shown in FIG. 20, when a Warm input request is received, 540, Warm input parameters may be received, 542. In an exemplary embodiment, the process flow 542 may start at 648 and may continue, in response to the input request, to blink WARM and MIN on the LCD and/or display the current time duration value of the warm, 650. If there is no current value, the default value may be 02:00. Upon the control system receiving the time input parameters from user input, 652, MIN may stop blinking, but WARM may continue to blink, 654. After receiving the Program Set input, 656, WARM may stop blinking and may remain on, 658. From 658, the process flow 542 may then end, 660.

Referring to FIG. 22, an exemplary process flow 552 of receiving Cooking stages after receipt of a Cooking State input request is described in further detail, according to an exemplary embodiment of the invention. In an exemplary embodiment, as shown in FIG. 20, cooking stages may be received 552 after a Cooking Stage input request has been received, 550. In an exemplary embodiment, the process flow 552 of cooking stages may begin at 700 and may continue with blinking COOK on the LCD, 702. The control system may then display the current stage number, power level for the stage and time duration of the stage, 704. If there are no current values for any of the above elements, the default values of Stage ‘1’, “HI” power, and “00:00” min may be used, respectively. The control system may then wait for further user input. The system may then wait for a Cook Time input request, 710, a Power Level input request, 720, a Stage Cook input request, 730, and/or a Program Set input, 750.

If a Cook Time input request is received, 710, the system may blink MIN, 712. Upon receiving the Cook Time input parameters from user input for the Cooking Stage, 714, MIN may stop blinking, 716.

If a Power Level input request is received, 720, the system may blink the Power Level display box, 722. Upon receiving the Power Level input parameters from user input for the Cooking Stage, 724, the Power Level display box may stop blinking, 726.

If a Stage Cook input request is received, 730, the system may check whether the current stage has a non-zero Cook Time duration value, 732. If the duration value is non-zero, then the system may check whether the current stage is the last defined stage and that the maximum number of stages has not been reached, 734. If the current stage is the last defined stage and is not the maximum stage allowed, the system may create a new subsequent stage and proceed to that stage, 736, displaying and assigning values as previously described for, 704. If the current stage is not the last defined stage and/or the current stage is the maximum stage allowed, the system may proceed to the subsequent existing stage, 740. In the case where the current stage is not the last defined stage, the subsequent existing stage may be the next numerical stage. In the case where the current stage is the maximum stage allowed, the subsequent existing stage may be the first stage, Stage 1. If the current stage cooktime is not non-zero, the current stage may be cancelled, 738, which may require the system to automatically renumber any subsequent stages, and the system may proceed to the subsequent existing stage. In the case where the current cancelled stage was the last stage, the subsequent existing stage may be the first stage, otherwise, the subsequent existing stage may be the following stage. If the program set request is received, 750, the system may stop blinking COOK and leave COOK lit, 752 and may end receiving cooking stage input. The process 552 may then end at 754.

In an exemplary embodiment, the oven may accept commands for actions such as, e.g., but not limited to, pause, start, clear, display sensor data, and/or reheat, etc. An exemplary pause command may suspend execution of the recipe. An exemplary start command may unpause execution. An exemplary clear command may clear current programming information being entered. An exemplary display sensor data command may display on the interface, sensor information, such as, e.g., but not limited to, temperature and/or level of doneness, etc. An exemplary reheat command may set the power level to “HI” for 4 minutes. According to an exemplary embodiment, commands may be received and executed during the multi-stage cooking recipe programming and/or during execution of a multi-stage cooking recipe.

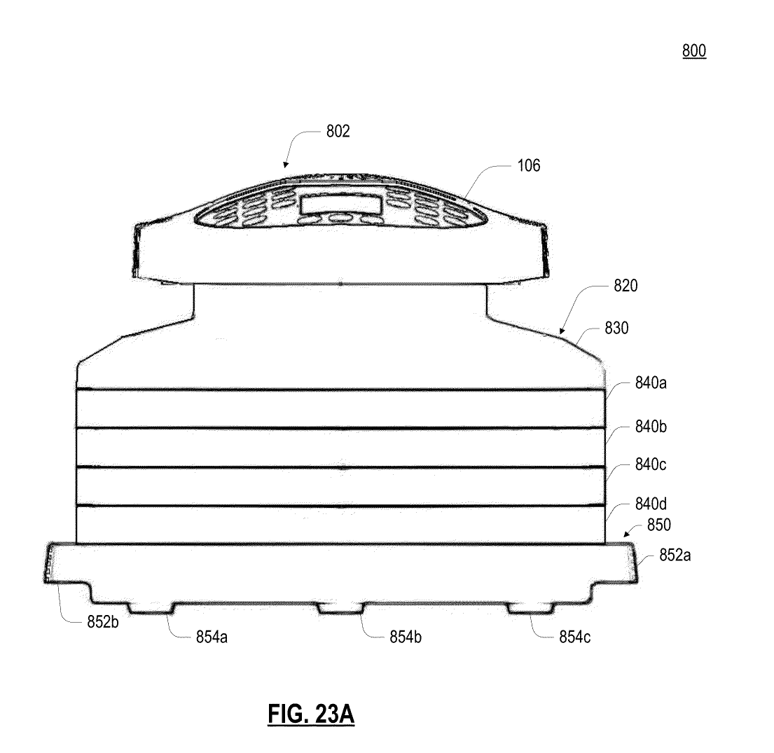

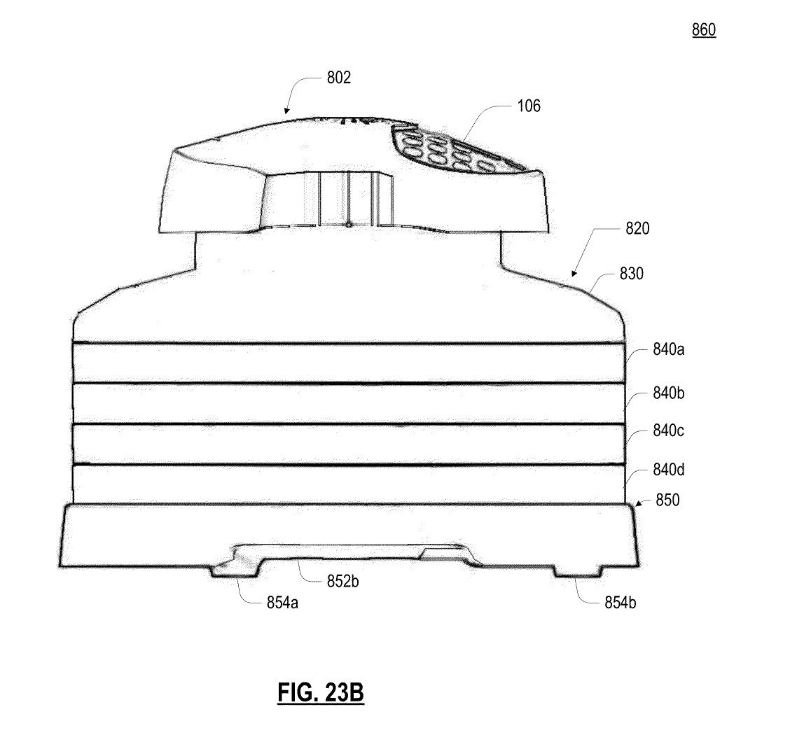

FIG. 23A-B depict exemplary front and side views of an exemplary embodiment of a dehydrator which may be used in accordance with the present embodiments.

In an exemplary embodiment, the dehydrator may dehydrate food. According to an exemplary embodiment, an exemplary such dehydrator may include an exemplary power unit 802 and a dehydrating enclosure 820. In an exemplary embodiment, power unit 802 may provide and regulate dehydrating air for dehydrating food within the dehydrating enclosure 820. According to an exemplary embodiment, the power unit may be detachably connectable to a cooking enclosure 21 and a dehydrating enclosure 820. In an exemplary embodiment, the power unit may be the power head for the above noted multi-stage counter-top electric oven. In alternative exemplary embodiments, the power unit may comprise a heat source for any exemplary type of exemplary oven. In an exemplary embodiment, the power unit 802 may comprise one or more input, output and/or control interfaces, including ancillary equipment.

According to an exemplary embodiment, the power unit 802 may comprise a power source disposed inside the power unit and a control source operable to control the power source. According to an exemplary embodiment, the power source of the power unit may include a heating unit and a fan unit. In an exemplary embodiment, the heating unit may include a heating element operable to provide heat to an enclosure and a thermostat system operable to measure an internal temperature of the enclosure and provide input regarding the internal temperature to the control source. According to an exemplary embodiment, the thermostat system may include a thermistor operable to measure the internal temperature of the enclosure and a thermostat adjustable to set a desired temperature of the enclosure. In an exemplary embodiment, the fan unit may include a fan chamber and a fan mounted in the fan chamber operable to create a dehydrating air flow throughout any one of the cooking enclosure or the dehydrating enclosure.

For example, in an exemplary embodiment similar to the above noted description with respect to a multi-stage counter-top electric oven, the power unit 802 may include a control system 100 coupled to an exemplary motor 76 and a heating element 84 to control the flow of electric power to the motor 76 and to one or more heating elements 84 in response to signals from an exemplary thermostat 98 and an exemplary command signal input from an input interface 106 by a user (not shown). Here, the control system 100 may be configured to selectively power the heating element 84 at a number of power levels P from a minimum power to a maximum power. At each power increment P, the control system 100 may power the heating element(s) 84 when the thermistor 96 indicates that the temperature in the dehydrating enclosure 820 has fallen below a low temperature set point associated with the particular power level P. The control system 100 then may terminate power to the heating element 84 when the temperature indicated by the thermistor 96 exceeds a high temperature set point associated with the particular power level P. The control system may provide power continuously to the motor 76 during the heating operations regardless of the power level selected. In fact, in exemplary embodiments, the power unit 802 is the same power head 20, described above with respect to a multi-stage counter-top electric oven.

According to an exemplary embodiment, the exemplary power unit 802 may be the NuWave Oven Pro manufactured by Hearthware Home Products of Gurnee, Ill., USA.

In an exemplary embodiment, an exemplary control source may include a processor operable to execute a multi-stage dehydrating process with the power unit, an input interface 160 operable to receive the multi-stage dehydrating process for the power unit and a storage device operable to store the multi-stage dehydrating process in the power unit.

According to an exemplary embodiment, the exemplary input interface 160 may include a button allowing a user to instruct the power unit 802 to dehydrate. In an exemplary embodiment, a user may input a multi-stage dehydration process including a plurality of dehydration temperatures in the exemplary power unit 802.

According to an exemplary embodiment, the power unit 802 may change desired dehydration temperatures during dehydration. In an exemplary embodiment, the power unit 802 may also provide a user one or more notifications regarding dehydration, such as, for example, but not limited to, that a dehydration stage is complete, that a multi-stage dehydration process is complete, that a multi-stage recipe including at least one dehydration stage is complete, or that the position or location of one or more dehydrating trays needs changing, among others.

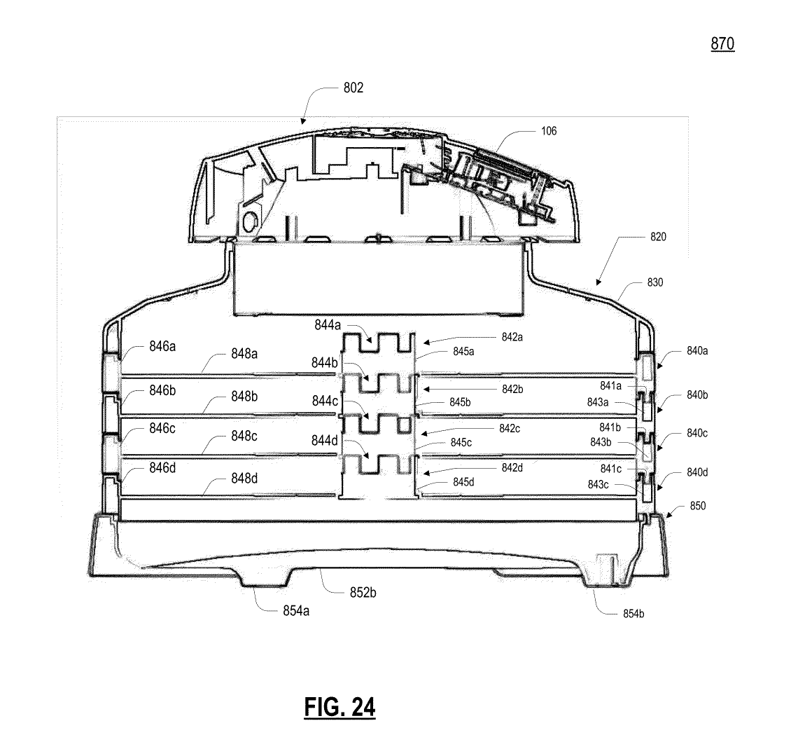

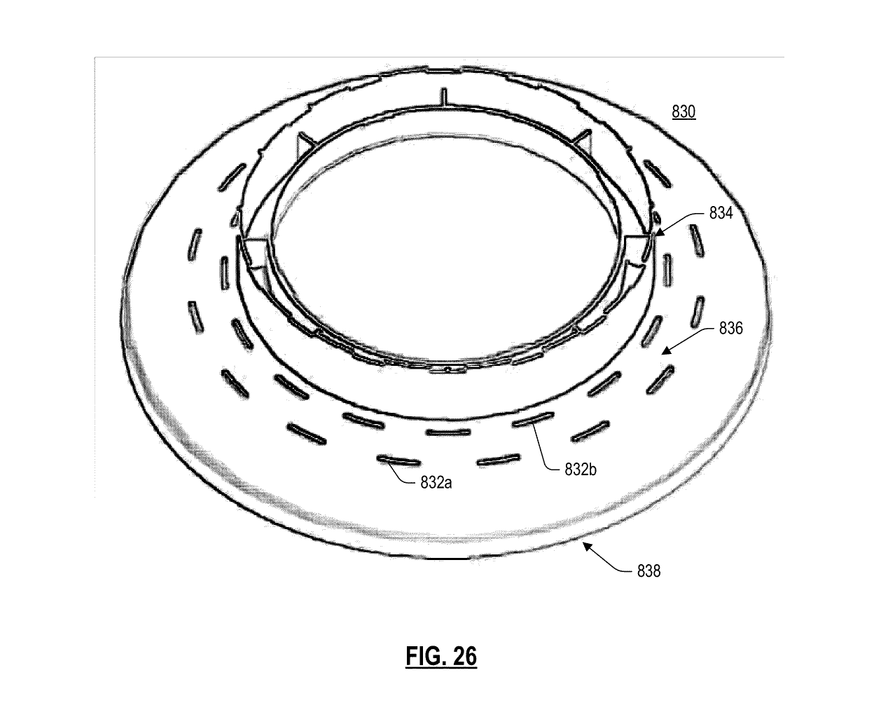

In an exemplary embodiment, the dehydrating enclosure 820 may include an exemplary adapter 830 (further described in FIG. 26) coupling the power unit 802 with the dehydrating enclosure 820. According to an exemplary embodiment, the dehydrating enclosure 820 may also include a plurality of dehydrating trays 840a, 840b, 840c, 840d (hereinafter collectively referred to as 840, further described in FIG. 24.) In an exemplary embodiment, the dehydrating enclosure 820 may also include an exemplary dehydrating base 850. According to an exemplary embodiment, the dehydrating base 850 may include one or more handles 852a and 852b (hereinafter referred to as 852.) In an exemplary embodiment, the dehydrating base 850 may include one or more exhaust vents (not shown) to allow air to exit the dehydrating enclosure 820. According to an exemplary embodiment, the dehydrating base 850 may include one or more raised feet 854a, 854b and 854c (hereinafter referred to as 854) lifting the dehydrating base 850, which may improve exiting airflow for one or more exhaust vents. According to an exemplary embodiment, at least a portion of the dehydrating enclosure 820 may be composed of polypropylene.

FIG. 24 depicts an exemplary sectional view of an exemplary embodiment of an exemplary dehydrator. According to an exemplary embodiment, a dehydrating tray 840 may support food and permit dehydrating air to circulate within a dehydrating enclosure 820. In an exemplary embodiment, a dehydrating tray 840 may be disc-shaped. According to an exemplary embodiment, a dehydrating tray 840 may include a substantially radial raised outer wall 846a, 846b, 846c, and 846d (hereinafter referred to as 846), a substantially radial raised inner ring 842a, 842b, 842c, and 842d (hereinafter referred to as 842), and a substantially flat inner loop portion 848a, 848b, 848c, and 848d (hereinafter referred to as 848)

In an exemplary embodiment, the outer wall 846 may form the wall of the dehydrating enclosure 820. According to an exemplary embodiment, the outer wall 846 may retain food and may retain dehydrating air within the dehydrating enclosure 820. In an exemplary embodiment, the outer wall 846 may form a plurality of openings 841a, 841b, and 841c (hereinafter collectively referred to as 841) on the top of the wall. According to an exemplary embodiment, the bottom of the wall may include a plurality of latches 843a, 843b, and 843c (hereinafter collectively referred to as 843) operable to lock into the openings 841 in the top of a wall of a lower tray. According to an exemplary embodiment, the openings 841 may be rectangular holes, and the tray 840 may be twisted so that the latches 843 slide into the holes of a lower tray and secure the tray to the lower tray.

In an exemplary embodiment, the substantially radial raised inner ring 842 may be positioned in a center portion of the outer wall 846. According to an exemplary embodiment, the substantially radial raised inner ring 842 may circulate dehydrating down and across a dehydrating tray 840. According to an exemplary embodiment, the inner ring may be fixedly and detachably mountable to a second dehydrating tray positioned on top thereof. In an exemplary embodiment, the inner ring may include a substantially vertical wall 845 forming one or more spaces 844 circulating dehydrating air between a central portion of the dehydrating tray and an orifice defined by the substantially vertical wall 845 and through which dehydrating air may be blown downward from the power unit 802.

According to an exemplary embodiment, the substantially flat radial inner loop 848 may include plurality of surfaces and form a plurality of openings. In an exemplary embodiment, the surfaces may support items to be dehydrated and the openings may permit air to pass through the tray 840. In an exemplary embodiment, air may be drawn in from the outside by a power unit 802. According to an exemplary embodiment, the air may then be heated by the power unit 802 and directed down through the raised inner ring 842 of at least one dehydrating tray. In an exemplary embodiment, the heated air may exit the rings 842 through spaces 844 in the rings. According to an exemplary embodiment, the heated air may pass through the substantially flat radial inner loop 848 of at least one dehydrating tray. In an exemplary embodiment, the heated air carrying moisture from articles being dehydrated may exit the cooking enclosure through one or more exhaust vents in a dehydrating base 850.

In an exemplary embodiment, the dehydrating trays 840 may be stackable. According to an exemplary embodiment, the dehydrating enclosure 820 may include one or more additional dehydrating trays respectively stacked on top of one another. According to an exemplary embodiment, the dehydrating enclosure 820 may be modular and the dehydrating trays 840 may be interchanged. In an exemplary embodiment, the dehydrating trays 840 may be identical.

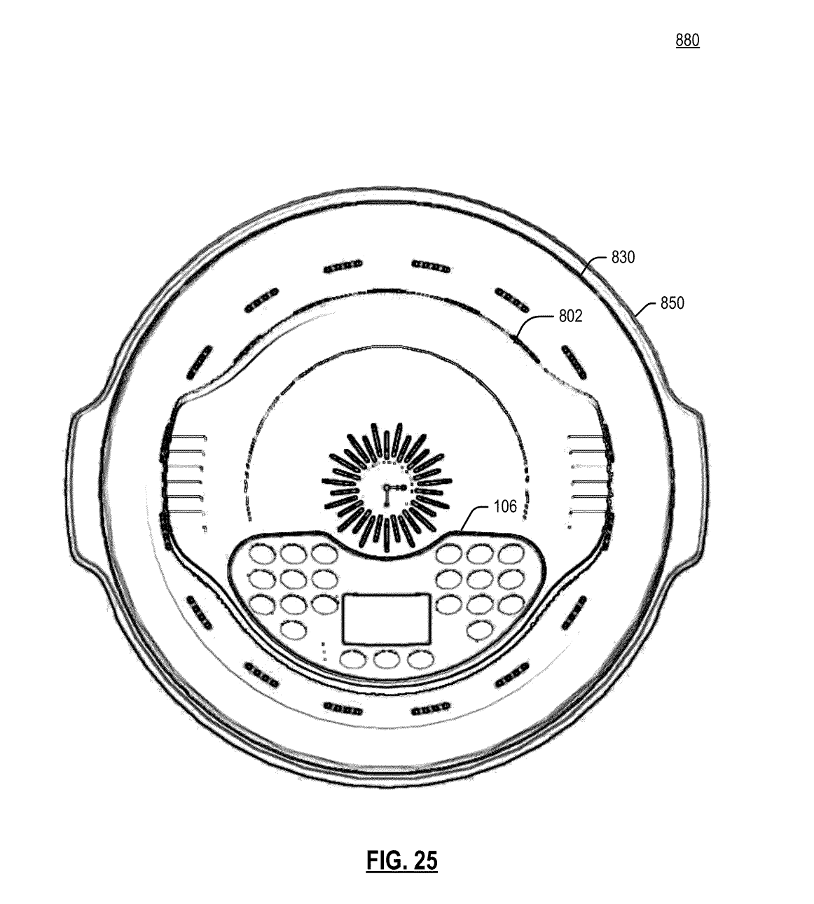

FIG. 25 depicts an exemplary top view of an exemplary embodiment of an exemplary dehydrator. In an exemplary embodiment, the multi-stage counter-top electric oven power unit 802 may be on top, with an adapter 830 immediately below, followed by at least one dehydrating tray 840, and ending on the bottom with a base 850.

FIG. 26 depicts an exemplary perspective view of an exemplary embodiment of an exemplary adapter 830 for an exemplary dehydrator. In an exemplary embodiment, the adapter 830 may couple the power unit 802 to a dehydrating tray 840. According to an exemplary embodiment, the adapter 830 may include an exemplary bottom portion 838 adapted to connect with a dehydrating tray 840 and an exemplary top portion 834 adapted to connect with a power unit 802. In an exemplary embodiment, the adapter 830 may also include an exemplary middle portion 836. According to an exemplary embodiment, the middle portion 836 may include at least one exemplary concentric row of a plurality of vents 832a and 832b (hereinafter referred to as 832.) In an exemplary embodiment, the vents 832 may exhaust air from the dehydrating enclosure 820. According to an exemplary embodiment, the vents 832 may be inch long slits in a circular pattern around the adapter 830.

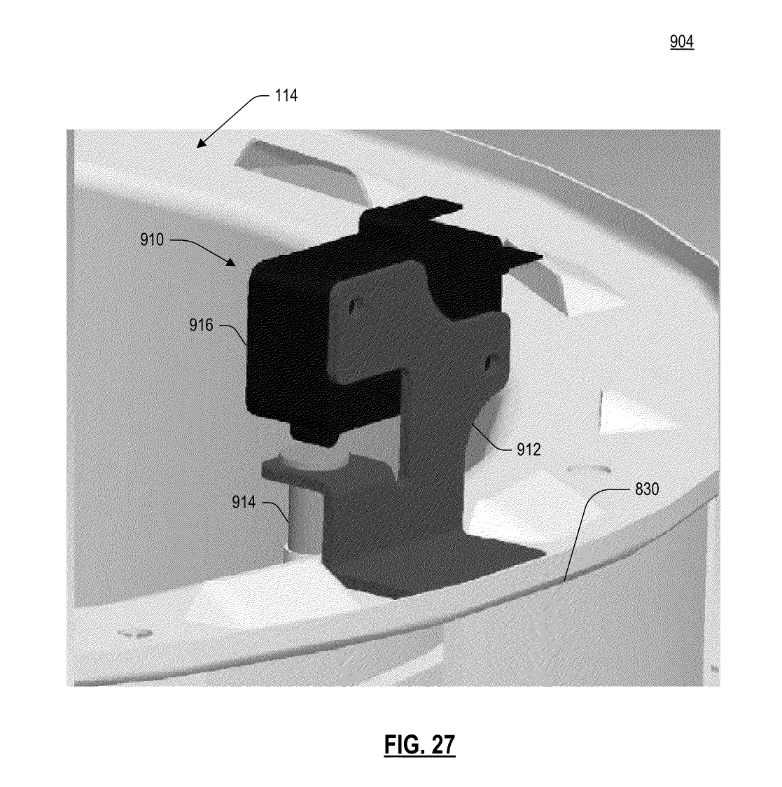

FIG. 27 depicts an exemplary perspective view of an exemplary embodiment of an exemplary sensor 910 for an exemplary power unit 802. In an exemplary embodiment, the power unit 802 may include a sensor 910. According to an exemplary embodiment, the sensor 910 may detect if the power unit 802 is attached to a dehydrating enclosure 820 or a cooking enclosure. In an exemplary embodiment, the detection process may determine an activation status of a switch, wherein the activation status includes at least a first status if the power unit is coupled with the dehydrating enclosure and a second status if the power unit is not coupled with the dehydrating enclosure. In an exemplary embodiment, the activation status may include a status for when the power unit is coupled with the cooking enclosure.

According to an exemplary embodiment, the power unit 802 may include safety features for dehydration, such as, e.g., but not limited to, the control source limiting the maximum desired temperature of the dehydrating enclosure when the power unit is detected to be coupled with a dehydrating enclosure. In an exemplary embodiment, the melting temperature of the dehydrating enclosure 820 may be lower than the maximum temperature capable of being produced by the power unit 802. According to an exemplary embodiment, the maximum temperature the power unit 802 may be capable of producing may be 550° F. degrees.

In an exemplary embodiment, the switch 910 may include an exemplary stand 912, an exemplary actuator 914, an exemplary actuator sensor 916. In an exemplary embodiment, the actuator 914 may be a column flanged on one end and threaded through a portion of the stand 912. According to an exemplary embodiment, the actuator sensor 916 may be connected to the stand 912 such that the actuator 914 may trigger the actuator sensor 906. In an exemplary embodiment, the stand 912 may be coupled, such as e.g., but not limited to, spot welding, with a portion of a power unit 802, such as, e.g., but not limited to, the cooling manifold 114 of a power unit.

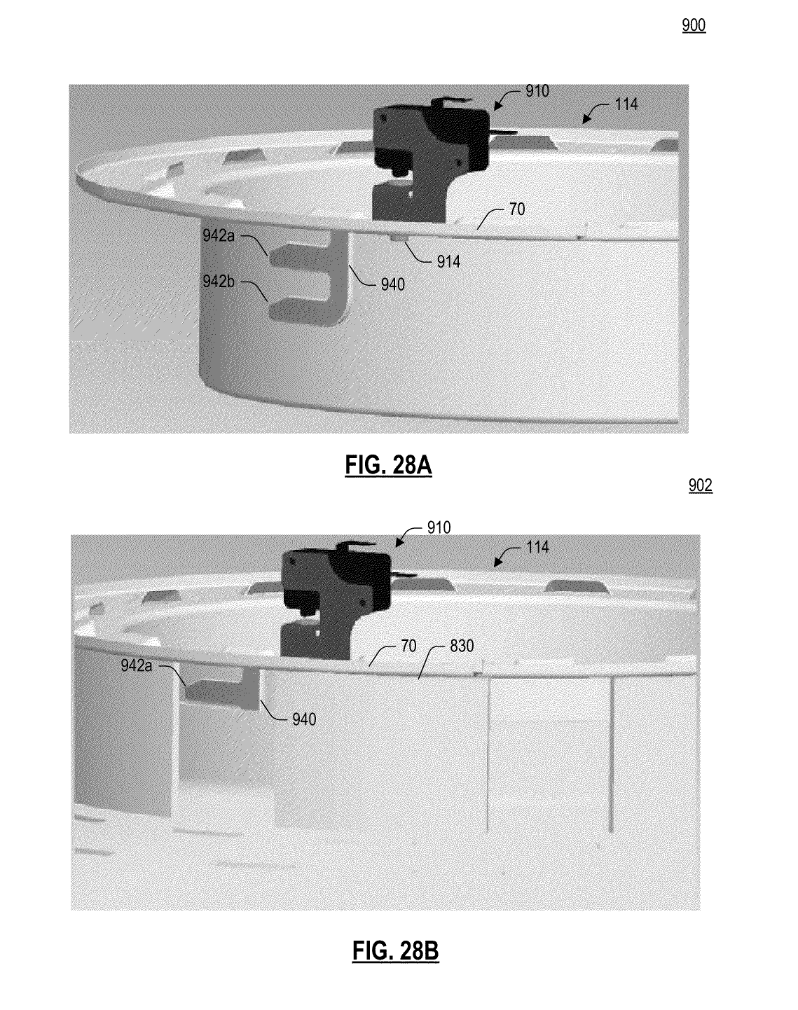

FIGS. 28A-B depict exemplary side views of an exemplary embodiment of an exemplary switch coupling with an exemplary dehydrating enclosure 820. In an exemplary embodiment, when a power unit 802 is coupled to a dehydrating enclosure 820, the adapter 830 may avoid the actuator 914 so as not to trigger an actuator sensor 916. According to an exemplary embodiment, the actuator 914 of the switch 910 may extend past a cooling manifold flange 70. According to an exemplary embodiment, a power unit 802 may also include a lock 940 securing the power unit 802 to a dehydrating enclosure 820. In an exemplary embodiment, a lock 940 may be two horizontally oriented prongs 942a and 942b between which a tab (not shown) on the adapter of the dehydrating enclosure 820 may be secured.

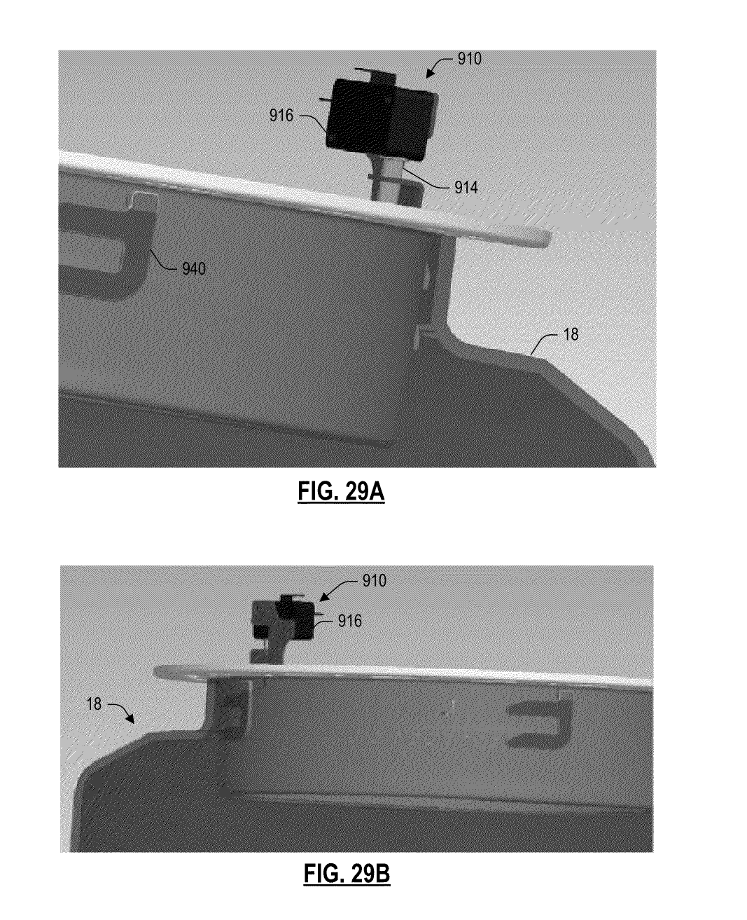

FIGS. 29A-B depict exemplary perspective views of an exemplary embodiment of an exemplary switch coupled with an exemplary cooking enclosure. According to an exemplary embodiment, the power unit 802 may be coupled with a cooking enclosure 21, and may cause a switch actuator 914 to trigger an actuator sensor 916. In an exemplary embodiment, the opposite may be true, coupling the power unit 802 to the cooking enclosure 21 may not trigger the switch sensor 916, but coupling the power unit 802 to a dehydrating enclosure 820 may trigger the switch sensor 916.

FIG. 30A depicts an exemplary embodiment of an improved user interface for a countertop oven illustrating various exemplary features and functions, which may include, according to an exemplary embodiment, LCD display, numeric keys, COOK TIME button, START button, COOK TEMP button, PROG button, DELAY button, SEAR button, PAUSE/CLEAR button, MEMORY button, WARM button, DEHYD (dehydrator mode) button, RECALL button, REHEAT button, and/or STAGE button, according to another exemplary embodiment.

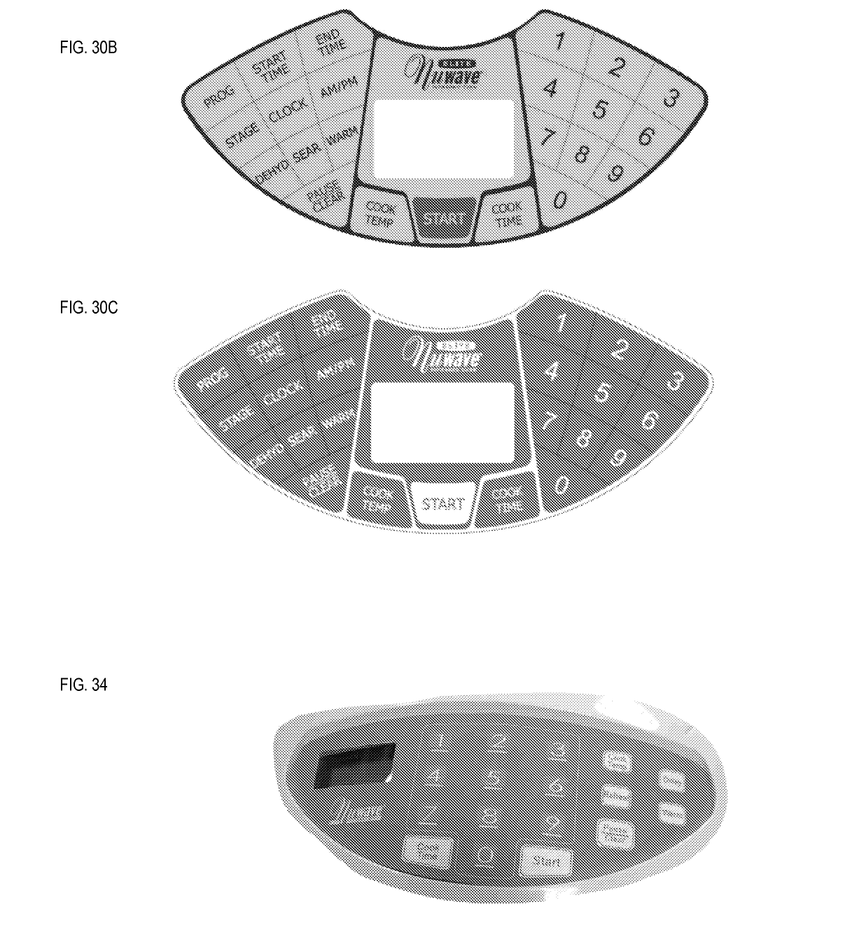

FIG. 31 illustrates an exemplary user interface illustrated on an exemplary oven power head, according to an exemplary embodiment.

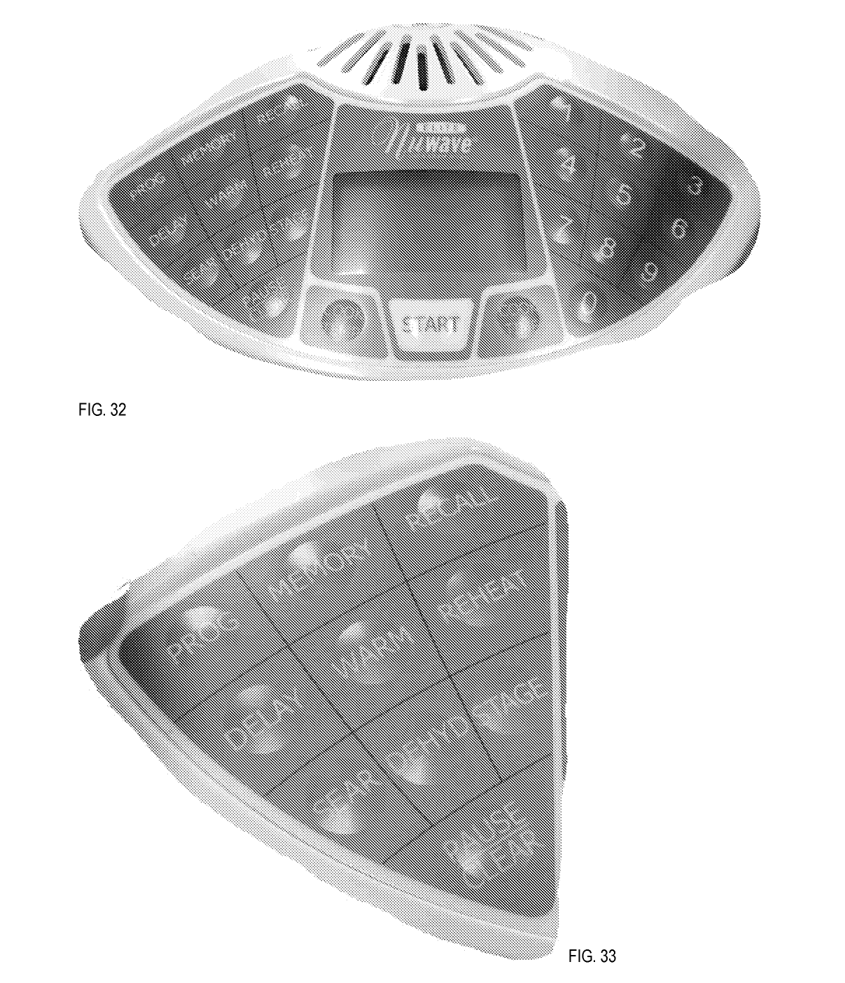

FIG. 32 illustrates an exemplary closeup of an exemplary user interface, according to an exemplary embodiment.

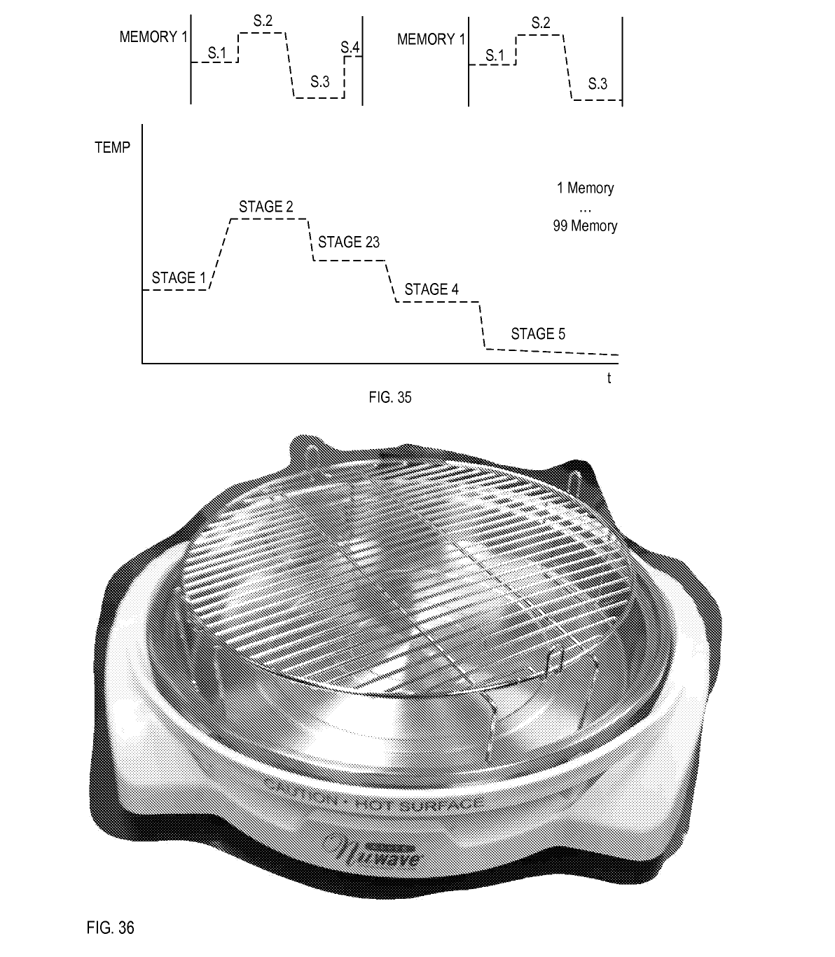

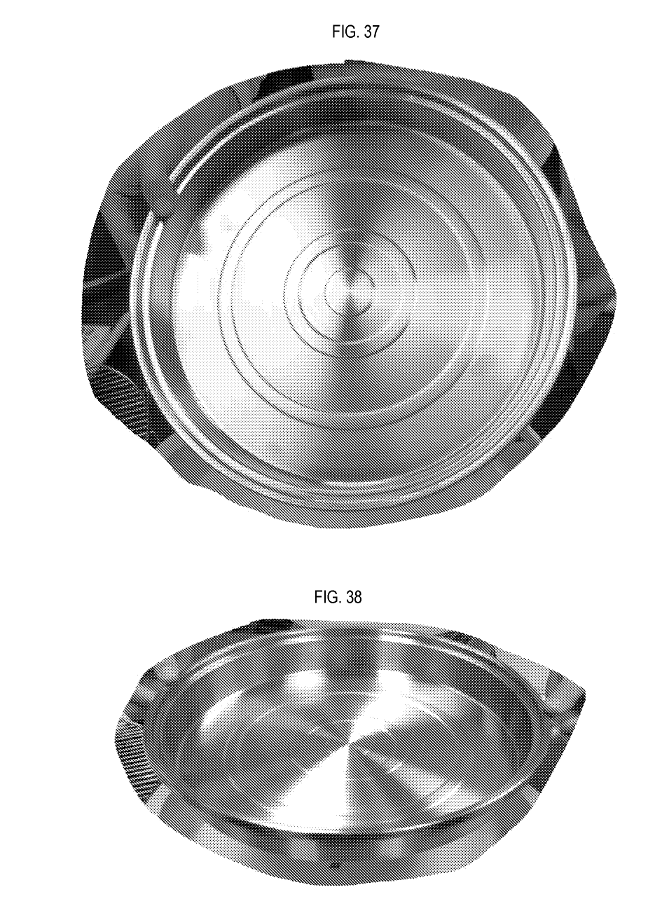

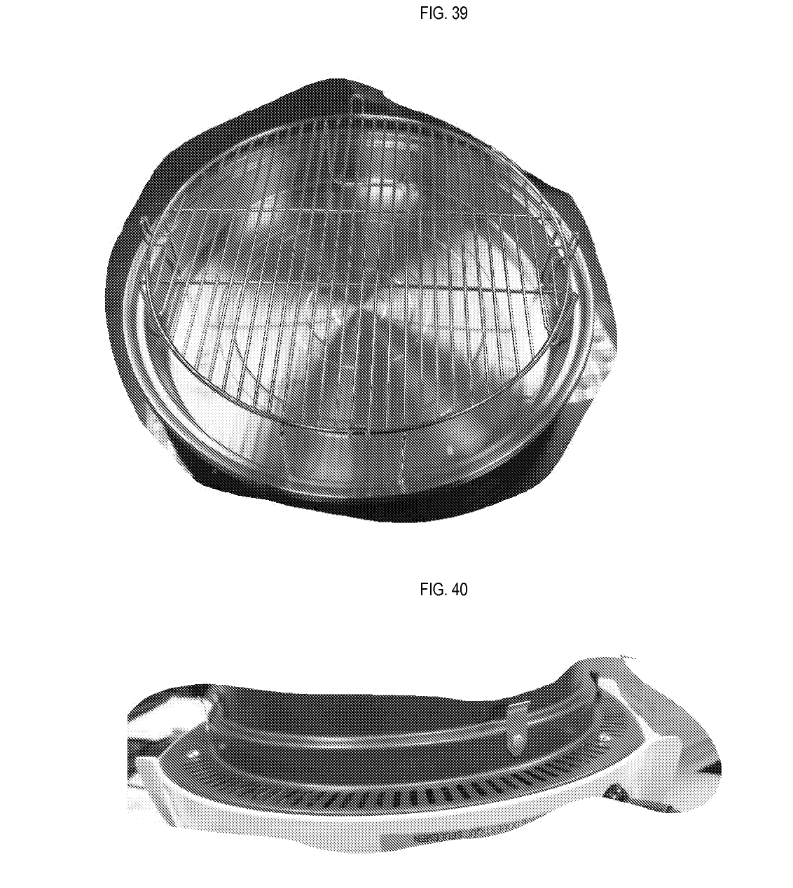

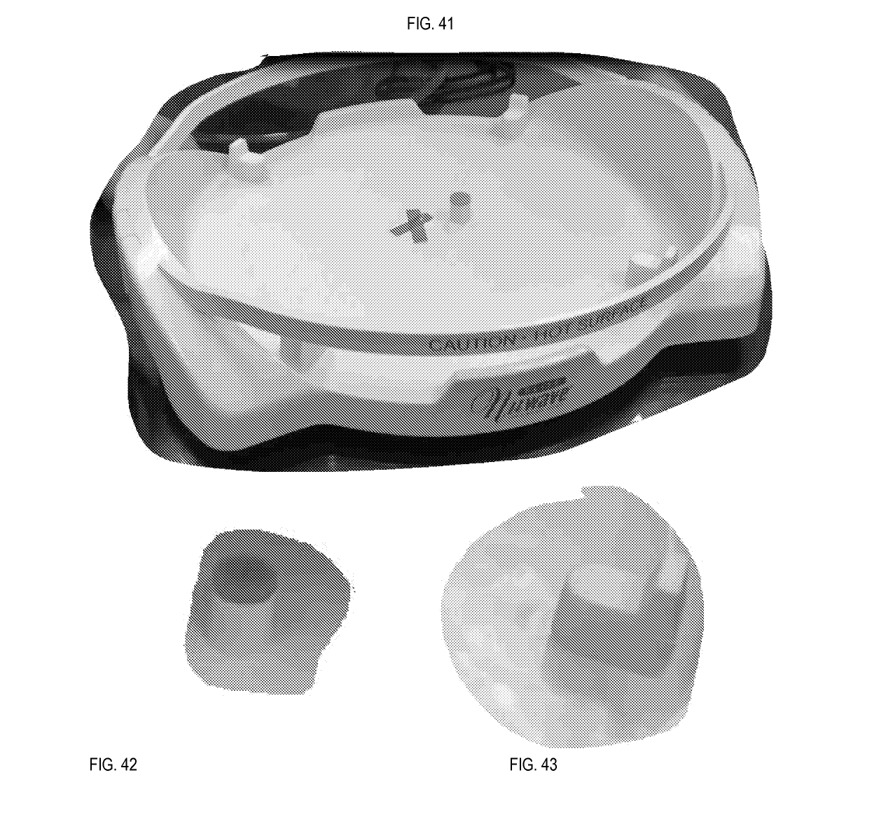

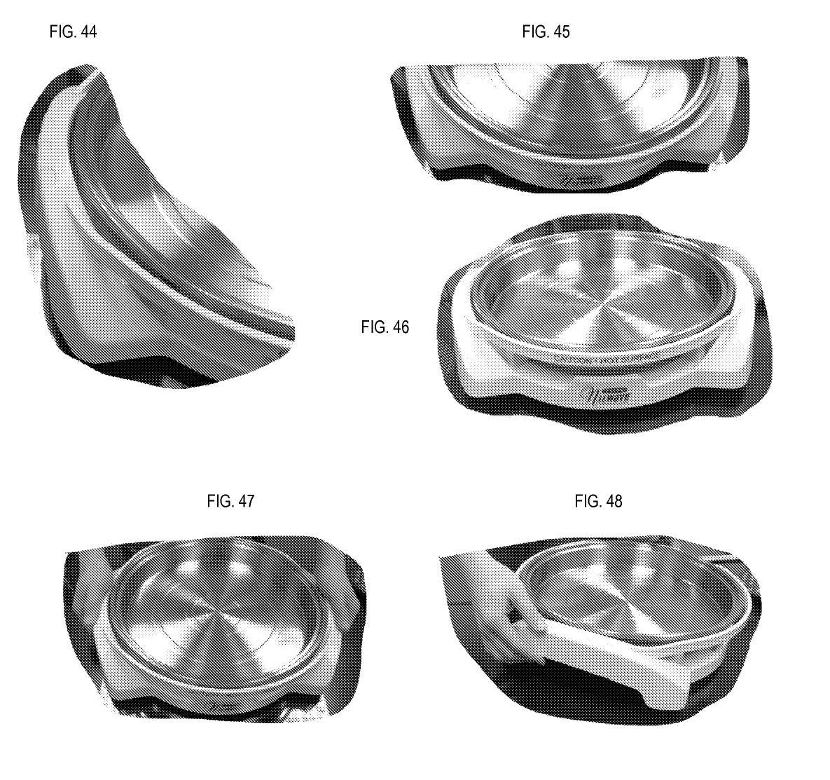

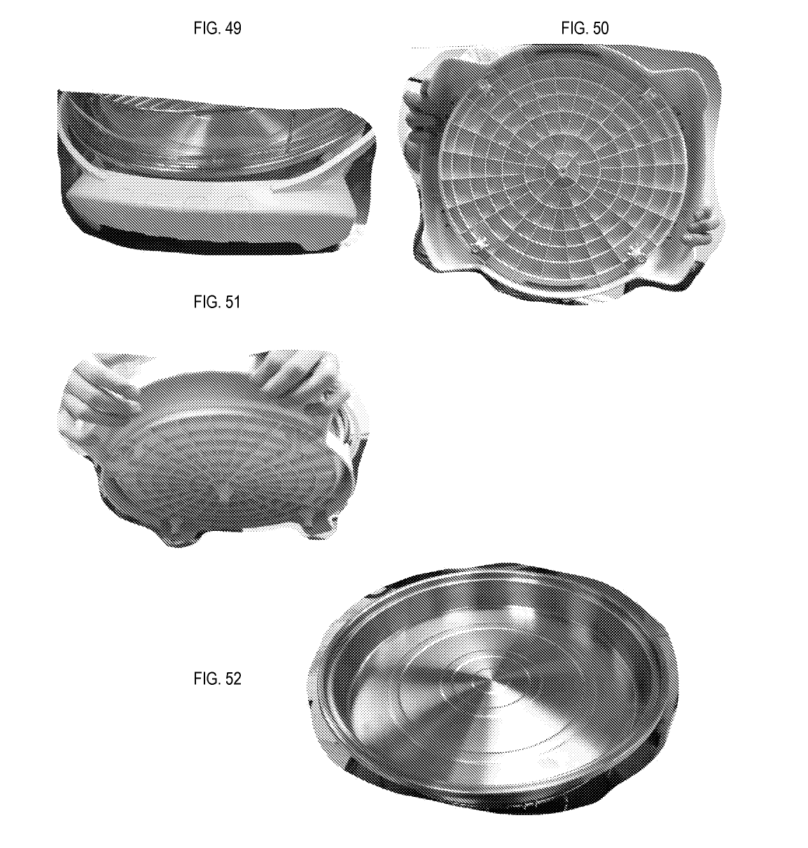

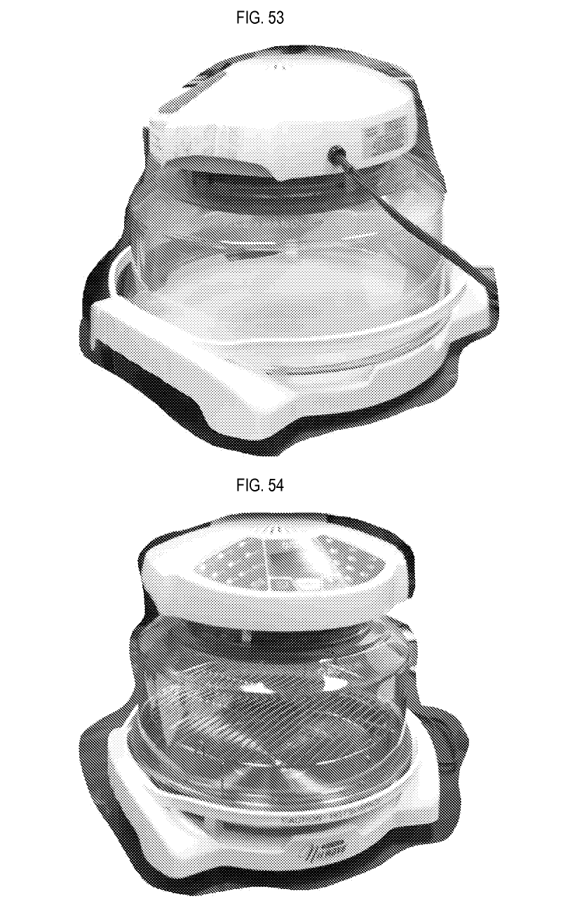

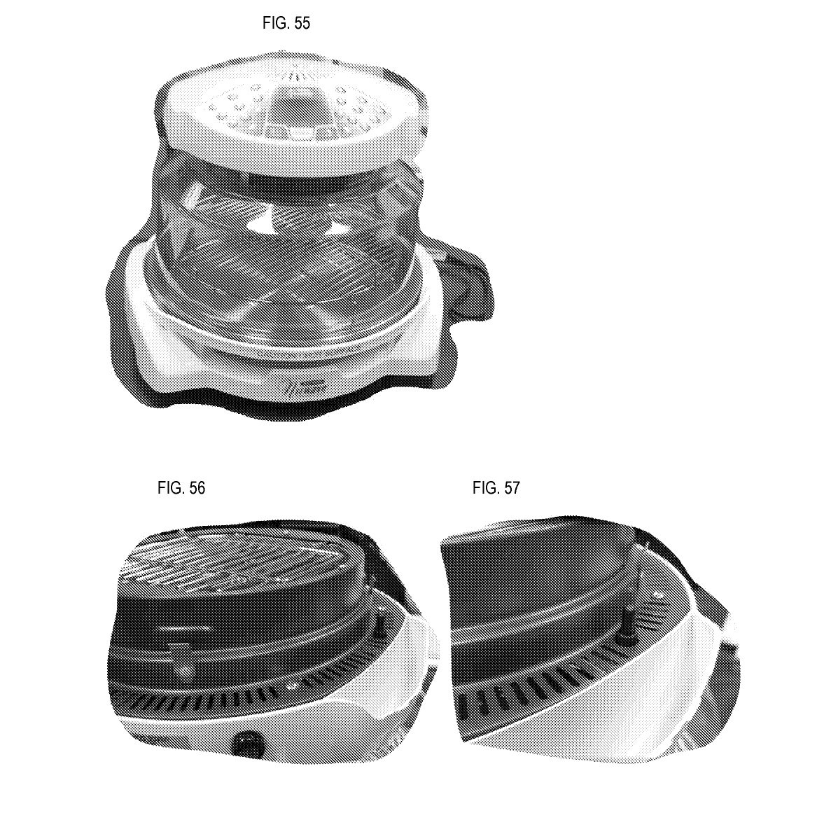

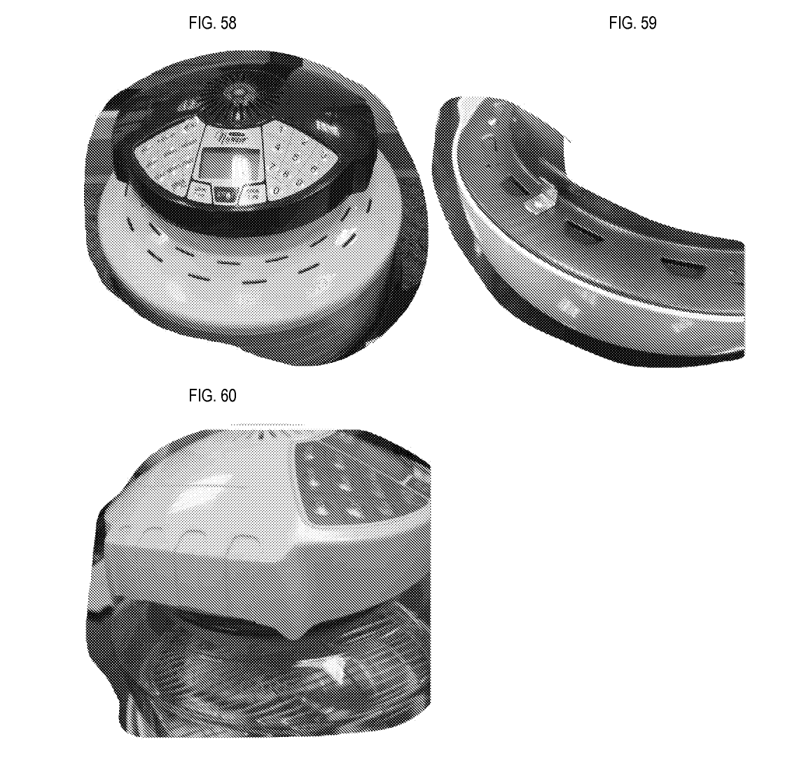

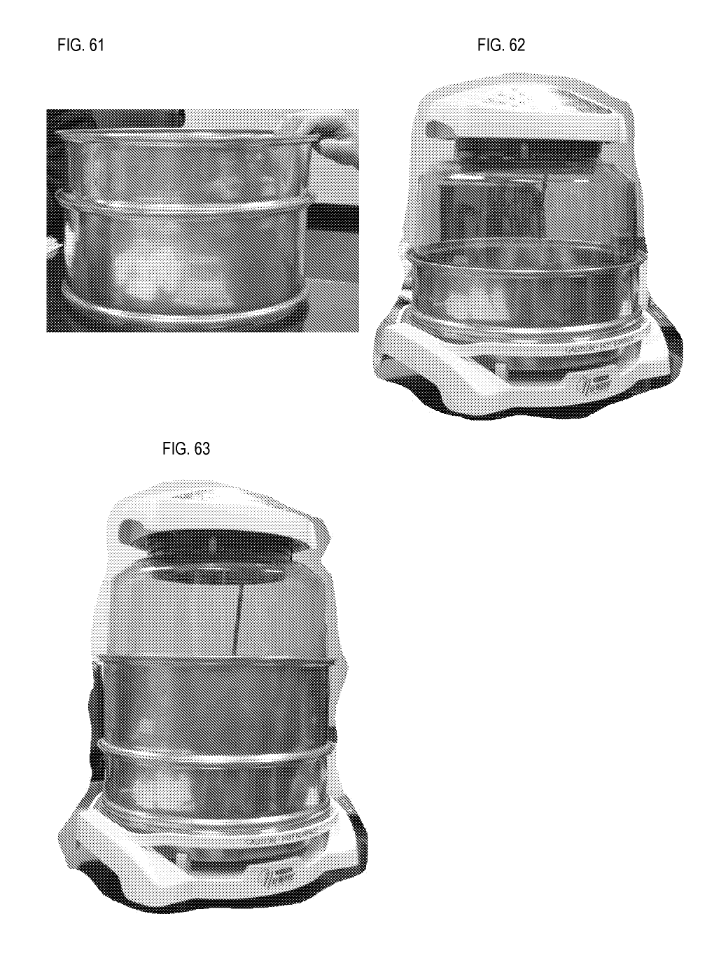

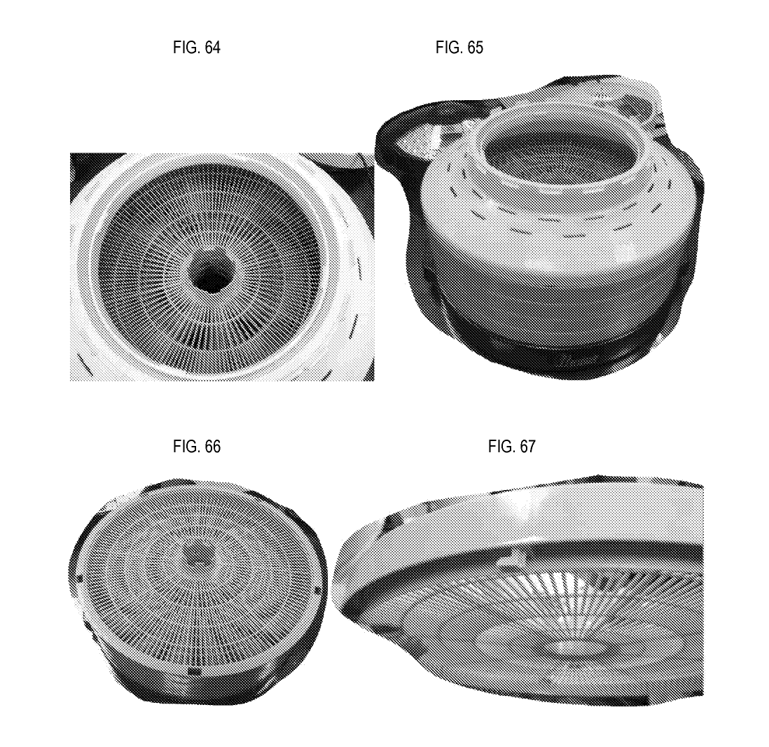

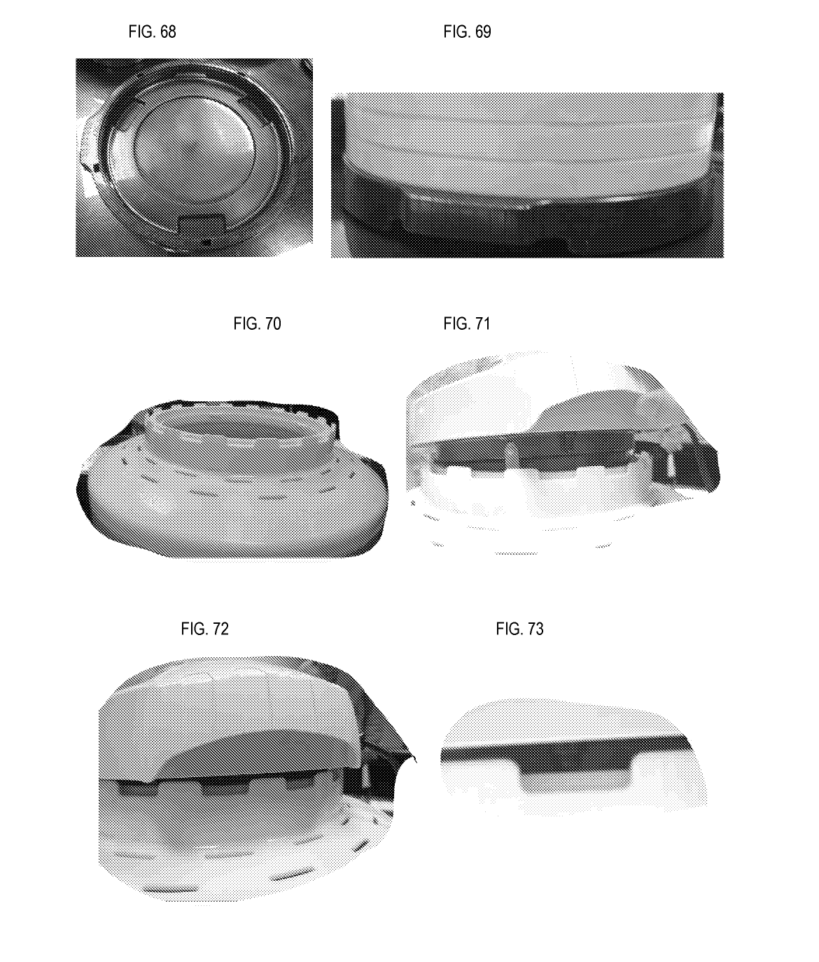

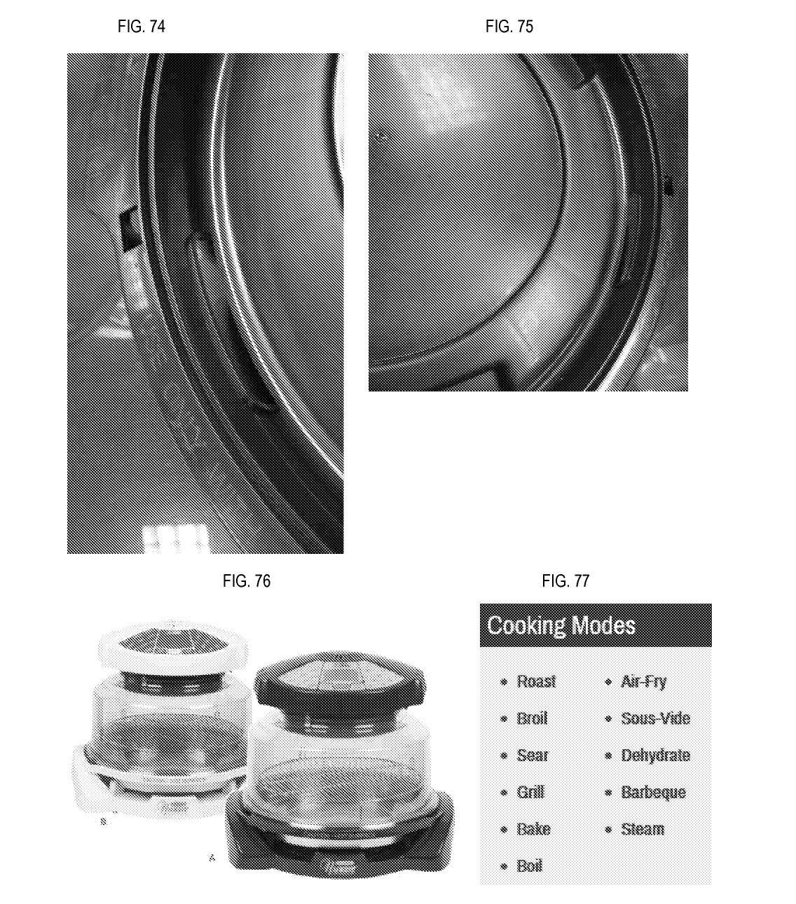

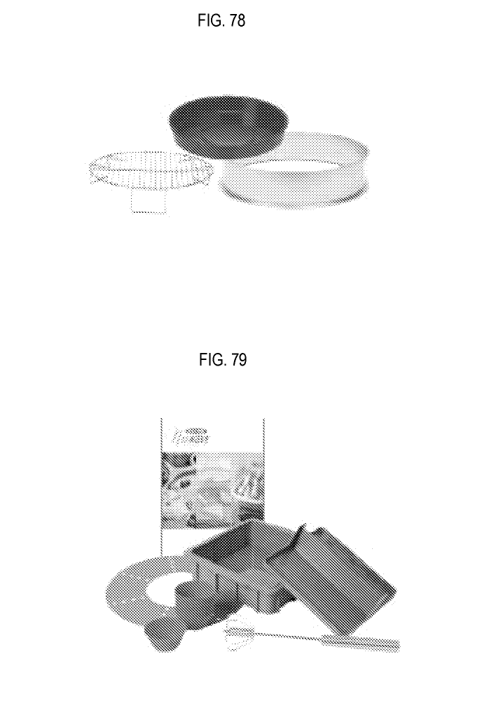

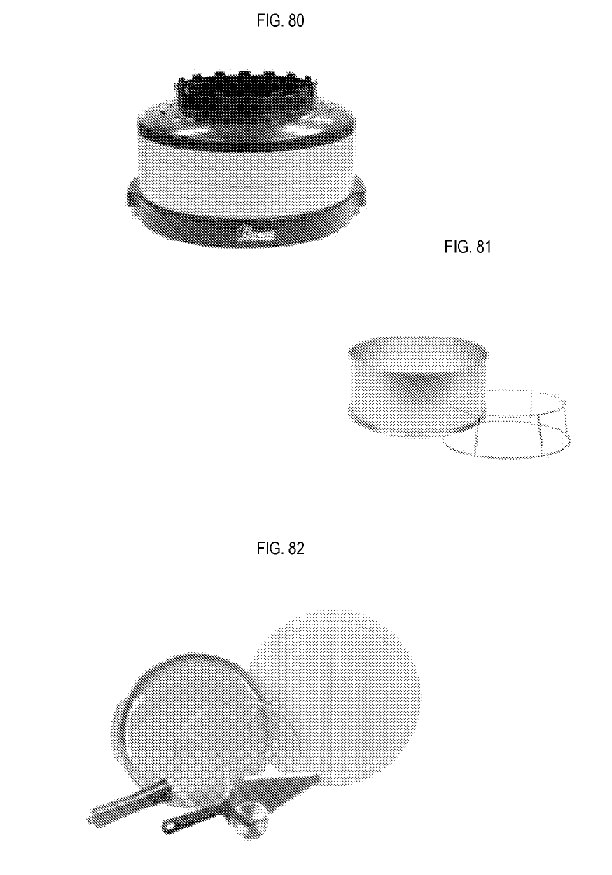

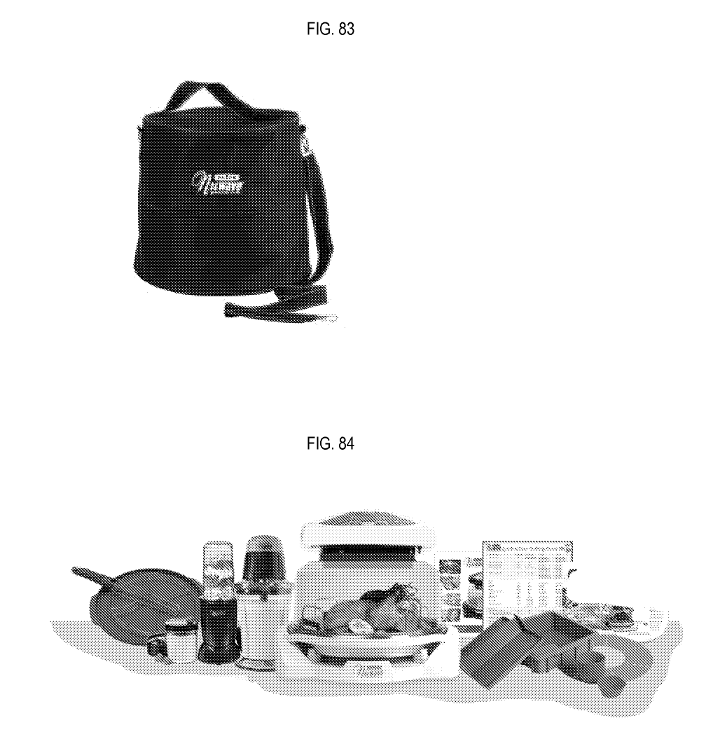

FIG. 33 illustrates an exemplary closeup of a portion of an exemplary user interface, illustrating an exemplary central circular button within each exemplary button.

FIG. 30B depicts one exemplary embodiment of a user interface for a countertop oven illustrating various exemplary features and functions, which may include, according to an exemplary embodiment, LCD display, numeric keys, COOK TIME button, START button, COOK TEMP button, PROG button, STAGE button, DEHYD button, PAUSE/CLEAR button, START TIME button, CLOCK button, SEAR button, END TIME, AM/PM button, WARM button, and/or STAGE button, according to another exemplary embodiment.

FIG. 30C depicts one exemplary embodiment of a user interface for a countertop oven illustrating various exemplary features and functions, which may include, according to an exemplary embodiment, LCD display, numeric keys, COOK TIME button, START button, COOK TEMP button, PROG button, DELAY button, SEAR button, PAUSE/CLEAR button, MEMORY button, WARM button, DEHYD (dehydrator mode) button, RECALL button, REHEAT button, and/or STAGE button; According to an exemplary embodiment, as compared to FIG. 30A,—DELAY, MEMORY, RECALL and REHEAT button (functions) have been eliminated in one exemplary embodiment, and exemplary START TIME, END TIME, CLOCK and AM/PM buttons (functions) may be added, according to various exemplary embodiments.

FIG. 34 depicts an exemplary embodiment of an alternative user interface for a countertop oven illustrating various exemplary features and functions, which may include, according to an exemplary embodiment, a smaller LCD display, numeric keys, COOK TIME button, START button, COOK TEMP button, DELAY button, PAUSE/CLEAR button, WARM button, and/or REHEAT button, according to another exemplary embodiment.

FIG. 35 illustrates an exemplary example illustration of a multistage recipe, which may be stored in memory locations 1 through 99, according to an exemplary embodiment, and each memo 1, and memo 2 also illustrated, may also include various stages, up to an architecturally set maximum number of stages, wherein each stage may have a temperature level, represented graphically by a vertical axis, and a temporal duration, i.e. a time period for an exemplary stage, as represented by a horizontal displacement in the illustration, according to another exemplary embodiment.

FIG. 36 depicts an exemplary embodiment of an exemplary alternative base with an exemplary stainless steel pan, and exemplary rack, according to an exemplary embodiment.

FIG. 37 depicts an exemplary top view of an embodiment of an exemplary stainless steel pan having various concentric exemplary rings on the pan's bottom surface, according to an exemplary embodiment.

FIG. 38 depicts an exemplary isometric view of an embodiment of an exemplary stainless steel pan illustrating an exemplary lipped edge of the pan, according to an exemplary embodiment.

FIG. 39 depicts an exemplary isometric view of an embodiment of an exemplary stainless steel pan with an exemplary two level wire rack placed within the pan, according to an exemplary embodiment.

FIG. 40 depicts an exemplary bottom edge view of an embodiment of an exemplary powerhead portion of an exemplary countertop oven, illustrating a plurality of exemplary venting holes, according to an exemplary embodiment.

FIG. 41 depicts an exemplary embodiment of the exemplary alternative base of FIG. 36 illustrating the base with the exemplary stainless steel pan removed therefrom, illustrating a plurality of exemplary feet further illustrated in FIG. 43 on which the pan may rest, as well as at least one silicon foot blown up in FIG. 42, near the center of the upper surface of the exemplary lower plastic base, also illustrating exemplary arc shaped guard portions to avoid injury from coming in contact with the pan, during heating, according to an exemplary embodiment.

FIG. 42 illustrates an exemplary foot with an exemplary silicone surface, according to an exemplary embodiment.

FIG. 43 illustrates an exemplary foot with exemplary horizontal and vertical support, according to an exemplary embodiment.

FIG. 44 illustrates an exemplary view of a gap between the edge of the pan and the edge of the base, according to an exemplary embodiment.

FIG. 45 illustrates an exemplary protective band, according to an exemplary embodiment.

FIG. 46 illustrates how the exemplary protective bands may prevent contact with the lip of the pan, according to an exemplary embodiment.

FIGS. 47 and 48 illustrate how the two handles on either side of the base may be used to lift and/or carry the base with the pan, which may be used as a serving tray, according to an exemplary embodiment.

FIG. 49 illustrates how the dome may be placed on the pan's lip within the protective bands, according to an exemplary embodiment.

FIG. 50 is a bottom view illustrating the bottom of the base with example feet, according to an exemplary embodiment.

FIG. 51 is an isometric view illustrating the bottom feet of the base, and illustrates an underside of an exemplary handle, according to an exemplary embodiment.

FIG. 52 illustrates an exemplary pan on top of a rack, according to an exemplary embodiment.

FIG. 53 illustrates an exemplary dome placed on top of the base, with an exemplary power head attached to the exemplary dome, in an exemplary stored position while the pan is being cleaned, supported on a ledge portion of the base, according to an exemplary embodiment.

FIG. 54 depicts an isometric view of a complete countertop oven with powerhead, dome, stainless steel pan, rack, and base, according to an exemplary embodiment.

FIG. 55 depicts a front view of the complete countertop oven with powerhead, dome, stainless steel pan, rack, and base, according to an exemplary embodiment.

FIGS. 56 and 57 depict an exemplary powerhead illustrating an exemplary safety switch for use with the dehydrator, and may be used to sense whether the power head is atop the dome or dehydrator dome, according to an exemplary embodiment.

FIG. 58 illustrates an exemplary powerhead atop an exemplary dehydrator dome and a stack of a plurality of exemplary trays, according to an exemplary embodiment.

FIG. 59 illustrates alternative air outlets in another alternative powerhead, according to an exemplary embodiment.

FIG. 60 illustrates an exemplary handle of the exemplary power head, according to an exemplary embodiment.

FIG. 61 depicts an exemplary embodiment of various exemplary stainless steel extender rings, according to an exemplary embodiment.

FIG. 62 depicts an exemplary embodiment of an exemplary powerhead and dome atop an exemplary stainless steel extender ring atop the stainless steel pan, according to an exemplary embodiment.

FIG. 63 depicts an exemplary embodiment of an exemplary powerhead and dome atop an exemplary pair of stainless steel extender rings atop the stainless steel pan, according to an exemplary embodiment.

FIG. 64 depicts an exemplary top view of an embodiment of an exemplary upper portion opening of an exemplary dehydrator dome, through which the powerhead may be inserted, according to an exemplary embodiment.

FIG. 65 depicts an exemplary isometric view of an embodiment of an exemplary upper portion atop four exemplary dehydrator trays, and illustrating an exemplary toothed opening of an exemplary dehydrator dome, through which the powerhead may be inserted, and illustrating an exemplary edge for interacting with the exemplary powerhead, according to an exemplary embodiment.

FIG. 66 depicts an exemplary top view of an embodiment of an exemplary dehydrator trays, illustrating exemplary openings through which air may flow for dehydrating foodstuffs placed on an exemplary tray/rack, as well as including exemplary openings in a horizontal surface, and toothed openings in a center cylindrical vertical portion for receiving locking portions from a bottom portion of another dehydrator tray as illustrated in FIG. 67, according to an exemplary embodiment.

FIG. 67 illustrates an exemplary bottom view of an exemplary dehydrator tray illustrating exemplary locking portions for interlocking with a corresponding opening in a top portion of another dehydrator tray, as shown in FIG. 66, according to an exemplary embodiment.

FIG. 68 illustrates an exemplary dehydrator base with exemplary opening in a top surface for receiving a locking mechanism from the bottom portion of a respective dehydrator tray as illustrated above in FIG. 67, according to an exemplary embodiment.

FIG. 69 illustrates an exemplary handle of the base of FIG. 68, according to an exemplary embodiment.

FIG. 70 illustrates an exemplary top cover dome portion of an exemplary dehydrator, according to an exemplary embodiment.

FIG. 71 illustrates placing a powerhead on the exemplary top cover dome portion of FIG. 70, and illustrates the button, which may be used to allow the exemplary powerhead to know that the powerhead has been placed on the dehydrator and to initiate the dehydrator operation of the powerhead automatically, according to an exemplary embodiment.

FIG. 72 illustrates the powerhead inserted into the circular opening of the top cover dome portion, and showing the dehydrator sensor button depressed, as shown in the blowup of FIG. 73, according to an exemplary embodiment.

FIG. 73 illustrates the dehydrator sensor button being depressed by a portion of the dehydrator top cover dome portion, according to an exemplary embodiment.

FIGS. 74 and 75 depict various exemplary openings allowing for airflow through the base of the exemplary dehydrator base, according to an exemplary embodiment.

FIG. 76 depicts two alternative white and black color schemes, according to an exemplary embodiment.

FIG. 77 depicts various exemplary cooking modes, according to an exemplary embodiment.

FIG. 78 depicts an exemplary extender ring kit, bundling an exemplary pan, cooking rack, and/or stainless steel extender ring, according to an exemplary embodiment;

FIG. 79 depicts an exemplary embodiment of an exemplary baking kit as may include an exemplary silicone tray, with exemplary silicone divider as may be used to cook two different exemplary cakes and/or breads, or the like, and may be used to remove the exemplary foodstuff from the tray, an exemplary circular silicone baking ring, exemplary cupcake liners; exemplary whisk, and an exemplary cookbook, according to an exemplary embodiment.

FIG. 80 depicts an exemplary dehydrator kit, according to an exemplary embodiment, including an exemplary top cover dome portion (also referred to as an adapter, a plurality of dehydrator trays, and/or an exemplary dehydrator base as discussed above, according to an exemplary embodiment.

FIG. 81 depicts an exemplary steel extender ring and exemplary roasting stand kit, according to an exemplary embodiment.

FIG. 82 depicts an exemplary pizza kit including an exemplary pizza flipper, server/cutter, a circular shaped silicone pizza liner, and/or an exemplary circular cutting board, according to an exemplary embodiment.

FIG. 83 depicts an exemplary embodiment of an exemplary lightweight, oven carrying case, according to an exemplary embodiment.

FIG. 84 depicts an exemplary embodiment of an exemplary combined kit of an exemplary oven and related cookbooks, CD, mixers, pizza flipper, and baking pans, according to an exemplary embodiment.

### Exemplary Touch 'n Go Digital Control Panel

### Stage

This function is used to program the Elite to cook at more than 1 consecutive setting of time and temperature, up to a maximum of 5 programmable stages

### Sear

For perfect searing to lock in foods' natural juices, this function allows you to treat the outside of meats, poultry and seafood quickly.

### Delay

Cook the perfect meal—even while you're away from home! Postpone single process or stage cooking programs to start up to 24 hours later.

### Warm

The perfect button for parties and family gatherings, this function allows you to hold foods warm after the cooking process is complete.

### Cooking Modes

An exemplary embodiment of the oven appliance, various exemplary cooking modes may be available, including at least one of:

Roast;

Air-Fry;

Broil;

Sous-Vide;

Sear;

Dehydrate;

Grill;

Barbeque;

Bake;

Steam; or

Boil.

### Exemplary Expanded Temperature Range

### Programmable in 1° Exemplary Increments

An exemplary embodiment of the oven appliance may support programming in 1 degree increments.

### Exemplary Electrical Consumption

An exemplary embodiment of the oven appliance may have the following exemplary energy usage:
1500 watts;
120 Volts; or
12.5 Amps.
   The NuWave Precision Induction Cooktop, according to an exemplary embodiment, may plug into any standard electrical outlet and can be transported anywhere. The oven may be appropriately sized for use in dormitories, small apartments, campgrounds, boats, and recreational vehicles (RVs).

### Light Weight

The exemplary oven appliance, according to an exemplary embodiment, may weigh a mere 10 pounds, which may make for easy portability and/or storage. When handled inside its original packaging (without accessories), the unit may weigh just under 12 pounds, according to an exemplary embodiment.

Volume When Used with the Extender Ring accessories
When using the 3-inch Extender Ring alone: 440 cubic inches
5-inch: 730 cubic inches
3-inch and 5-inch Extender Rings combined: 1,173 cubic inches

### Material Used to Construct Dome

An exemplary oven, according to an exemplary embodiment, may be made from polyphenylsulfone (PPSU), a material which may deliver superior impact resistance. The dome may be built to withstand temperatures up to, e.g., but not limited to, 420 degrees Fahrenheit while remaining free of harmful chemicals such as BPA. The dome, according to an exemplary embodiment, may be virtually-indestructible.

### Exemplary Maximum Temperature Range

According to an exemplary embodiment, an exemplary oven may include an exemplary maximum temperature range for cooking, programmatically, by exemplary program cooking temperatures ranging from, e.g., but not limited to, 100° to 420° F., in exemplary, but nonlimiting one (1) degree and/or other temperature range, increments, according to an exemplary embodiment. The Sear function maybe programmed at an exemplary default setting of e.g., but not limited to, 450° F., and/or higher, etc. According to one exemplary embodiment, the sear function may may have an exemplary fixed duration time period associated with cooking at that level. According to another exemplary embodiment, the sear feature may include an unlimited time period, if the oven is made of a material that may operate for extended periods of time, at the exemplary maximum temperature level, according to an exemplary embodiment. According to another exemplary embodiment, an oven may have other sensors to assist in ensuring the fan may turn off, when sufficiently cool, according to an exemplary embodiment.

### Exemplary Dimensions of an Exemplary Oven Embodiment

According to an exemplary embodiment, an exemplary oven may include the following example, but nonlimiting dimensions:
Exterior: 15.5 inches in width and 13.5 inches in height; or
Interior: 6.5 inches deep and 12 inches in diameter.

### Exemplary Sear Foods

For searing foods, according to an exemplary embodiment, to lock in foods' natural juices, an exemplary sear feature/function may allow treating, e.g., but not limited to, an outside surface of, e.g., but not limited to, meats, poultry and/or seafood, and/or other foodstuffs, for an exemplary quick time period, according to an exemplary embodiment. The exemplary sear feature, according to an exemplary embodiment, may heat dishes up to an exemplary temperature level of, e.g., but not limited to, 450° F. for an exemplary, but not limiting timer period, such as, e.g., but not limited to, five (5) exemplary minutes by use of an exemplary button, according to an exemplary embodiment.

Exemplary Reheat button

An exemplary reheat feature may include, according to an exemplary embodiment, an exemplary mechanism for reheating leftovers and other foods, according to an exemplary embodiment. The dish may be placed, e.g., but not limited to, directly, or indirectly, on the exemplary 1-inch rack, according to an exemplary embodiment, and an exemplary “Reheat” button may be depressed/selected, and then according to an exemplary embodiment, a “Start”button may be depressed/selected, according to an exemplary embodiment.
If you are warming larger portions of food, according to an exemplary embodiment, the food may be cooked in exemplary 3 minute, and/or other time period, exemplary increments, according to an exemplary embodiment.
For casseroles or family-sized meals, an oven-safe dish may be placed on the exemplary 1-inch rack and may be cooked at an exemplary 300° F. in, exemplary, but nonlimiting, 8 minute and/or other time period, increments. If the exemplary food is browning too quickly, the food may be covered with foil and/or the like, according to an exemplary embodiment.
To reheat rice or noodle dishes, the dishes may be placed in or on foil or an included exemplary silicone liner accessory, according to an exemplary embodiment. According to an exemplary embodiment, a liner may be situated on an exemplary 1-inch rack, and the oven may receive an exemplary “Reheat” button depression, according to an exemplary embodiment. If reheating basic rice, and/or pasta, according to an exemplary embodiment, the user may wish to sprinkle a small amount of water on top of the food before cooking to enhance cooking, according to an exemplary embodiment. The food and water may be covered loosely with foil, according to an exemplary embodiment and may be cooked in exemplary 4 minute, and/or other time period increments, according to an exemplary embodiment.

### Exemplary Delay

An exemplary delay function may be used to initiate cooking at a later time, such as,e.g., but not limited to, while the user may be away from the oven, according to an exemplary embodiment. According to an exemplary embodiment, postponing an exemplary single process, and/or stage cooking programs to start, may be, according to an exemplary embodiment, delayed to begin for an exemplary, up to 24 hours, etc., later.

### Exemplary Warm Feature

An exemplary warm feature button may be useful for maintaining an exemplary low heat level, particularly useful, e.g., but not limited to, for parties, catering, and/or family gatherings, this exemplary warming function may allow the oven to hold foods warm after the cooking process is complete, for, e.g., for up to 2 hours, etc., according to an exemplary embodiment.

### Exemplary Stage Feature

According to an exemplary embodiment, a stage cooking feature or function may be used to program an exemplary embodiment of the countertop oven to cook at more than 1 consecutive setting of, e.g., but not limited to, time and temperature, up to an exemplary maximum number of stages, such as, e.g., but not limited to, an exemplary five (5) programmable stages, according to an exemplary embodiment. For example, according to an exemplary embodiment, you can program the oven to cook at 420° F. for 6 minutes, then automatically reduce heat to 350° for 20 minutes, according to an exemplary embodiment. Up to an exemplary maximum number of stages per recipe, such as, e.g., but not limited to, may include 5 stages, and up to 99 storage memory locations, according to an exemplary embodiment.

### Exemplary Program, Memory and Recall Buttons

According to an exemplary embodiment, a user may store program parameters for a favorite dish or recipe, e.g., but not limited to, saving in oven memory, an example continually used Program sequence for future use, according to an exemplary embodiment. The exemplary Memory function, according to an exemplary embodiment may retain the recipe program information while an exemplary Recall button may be used to retrieve a stored program. An exemplary countertop oven, according to an exemplary embodiment, may allow users to store up to an exemplary 99 saved programs, according to an exemplary embodiment.

### Exemplary Dehydrator Food Feature Kit

With an exemplary dehydrator embodiment, the exemplary oven may dehydrate foods such as, e.g., but not limited to, fruits, nuts, vegetables and jerkys, etc. while preserving healthy enzymes and nutrients in the foods. The exemplary dehydrating feature may allow removing moisture from foods at temperatures ranging between, e.g., but not limited to, 100 and 200° F. in 1 degree increments, according to an exemplary embodiment. A Dehydrator Kit, according to an exemplary may include, various safety features to automatically convert and/or revert to the “dehydrate” setting, according to an exemplary embodiment.

Exemplary Broil, Bake, Roast, Bbq, Grill, Dehydrate, Steam, Air-Fry and Cook Sous-Vide Style.

### How to Perform Exemplary Multi-functions

### Exemplary Special Button for Automatic Program Settings

Your Elite can do all the above and much more. There are automatic program settings for dehydrating, reheating and warming foods, and here are some additional guidelines for use:
To steam: cover foods after sprinkling with a slight amount of water and your desired seasonings.
To air-fry: coat foods with wet mix and roll in cornflakes or bread crumbs. For additional browning, rub in olive oil or spray with cooking spray. Leftover fried foods will come out of your Elite crispier than the first time.
To broil: place foods closer to heating element.
To roast: place foods further from heating element, and lower the cooking temperature.
For sous-vide cooking, place foods in air-tight cooking bags. Situate on the 1-inch rack and cook according to recommended time and temperature.
   Exemplary Sous-Vide cooking

Sous-vide is a French culinary term that means “under vacuum.” It describes a method of cooking in vacuum-sealed plastic pouches at low temperatures for extended periods. With the proper equipment and some basic information, anyone can prepare consistently delicious sous-vide dishes. Please see the NuWave Elite Complete Cookbook for more information as well as some suggested recipes to get you started.

### Exemplary 1-Inch or 3-Inch Racks

A cooking rack, according to an exemplary embodiment, can be reversed for use at heights of either 1 inch or 3 inches, etc. according to an exemplary embodiment may include, e.g., but not limited to:
The 3-inch rack accommodates smaller foods such as chicken breasts, according to an exemplary embodiment; or
The 1-inch rack accommodates larger foods such as a 10-pound turkey, according to an exemplary embodiment.

### Exemplary Extender Ring

Without the optional Extender Rings, you can cook up to a 10-pound turkey in the Elite, according to an exemplary embodiment. However by combining the use of our 3-inch and 5-inch Extender Rings, according to an exemplary embodiment, you can increase the capacity of the oven and cook up to a 30-pound turkey. This capability, according to an exemplary embodiment, may be used as a combination, which may be referred to as the Deluxe Elite Extender Ring Kit, according to an exemplary embodiment.

Exemplary Two Differently Sized Extender Rings. Optionally Use Both

The possibilities are endless with the Deluxe Elite Extender Ring Kit, according to an exemplary embodiment. The Kit may include a roasting rack for cooking large cuts of meat, and the two different rings may offer the following options, according to an exemplary embodiment:
With the 3-inch stainless steel ring, according to an exemplary embodiment, the Elite may cook up to a 16-pound turkey.
The 5-inch ring, according to an exemplary embodiment, may allow users to make up to a 24-pound turkey.
By combining the 3-inch and 5-inch rings stainless steel rings, according to an exemplary embodiment, may prepare up to a 30-pound turkey.

### Exemplary Types of Pans Can Safely be Used

Any cooking utensils that can be used in a conventional oven can also be used in the NuWave Elite, according to an exemplary embodiment. Items made of foil, metal or Pyrex™, oven-safe cooking bags and even prepared frozen entree trays are safe for use in the NuWave Elite, according to an exemplary embodiment. If it can go into a regular oven, it can be used in the NuWave, according to an exemplary embodiment.

### Exemplary Kit

NuWave Elite Oven
Silicone Baking Kit & NuWave Elite Baking Book
Elite Pizza Kit
NuWave Elite Complete Cookbook
Instructional DVD
NuWave Cooking Club Lifetime Membership
90-Day Money-Back Guarantee
Express Day Shipping (Within 48 States)
1-year Top-to-Bottom Warranty

While various embodiments of the present invention have been described above, it should be understood that they have been presented by way of example only, and not limitation. Thus, the breadth and scope of the present invention should not be limited by any of the above-described exemplary embodiments, but should instead be defined only in accordance with the following claims and their equivalents.

What is claimed is:

1. A power unit, comprising:
a heating element coupled to the power unit; and
a controller operable to control said heating element;
wherein said power unit comprises a programmable controller adapted to store a plurality of multi-stage recipes; and
wherein said power unit being detachably connectable to one of both:
a cooking enclosure; and
a dehydrating enclosure.

2. The power unit according to claim 1, wherein the power unit is a power head.

3. The power unit according to claim 1, wherein said power unit comprises at least one of:
a thermistor operable to measure the internal temperature of said enclosure; or
a thermostat adjustable to set a desired temperature of said enclosure.

4. The power unit according to claim 1, wherein the control source comprises a sensor operable to determine whether the power unit is coupled to the cooking enclosure or the dehydrating enclosure.

5. The power unit according to claim 1, wherein the power unit is coupled to the cooking enclosure, and wherein the control source comprises:
an input interface operable to receive a multi-stage cooking recipe;
a storage device operable to store the multi-stage cooking recipe; and
a processor operable to cause the power source to execute the multi-stage cooking recipe.

6. The dehydrating device according to claim 1, wherein said dehydrating tray comprises:
a substantially radial raised outer wall,
the wall forming a plurality of openings on the top portion thereof,
the wall comprising a plurality of latches on the bottom portion thereof, the latches operable to connect with one or more openings on the top portion of a second dehydrating tray positioned on the bottom of said dehydrating tray.

7. The dehydrating device according to claim 1, wherein said dehydrating tray forms a substantially radial raised inner ring positioned in a center portion of the outer wall, the inner ring being fixedly and detachably mountable to a second dehydrating tray positioned on top thereof.

8. The dehydrating device according to claim 7, wherein the inner ring comprises a substantially vertical wall forming one or more spaces circulating dehydrating air between a central portion of the dehydrating tray and an orifice defined by the substantially vertical wall and through which orifice dehydrating air is blown downward from the power unit.

9. The dehydrating device according to claim 1, wherein said dehydrating tray comprises:
a substantially flat inner loop portion coupling the radial raised outer wall to the radial raised inner ring, the flat inner loop portion comprising a plurality of surfaces having openings therebetween.

10. The dehydrating device according to claim 1, wherein the dehydrating enclosure further comprises one or more additional dehydrating trays respectively stacked on top of one another and said at least one dehydrating tray.

11. The power unit according to claim 1, wherein said dehydrating enclosure comprises:
a top cover dome adapter;
a bottom comprising at least one water pool;
a plurality of trays,
wherein each dehydrator tray comprises:
at least one hook; and
at least one hole for receiving said at least one hook of another of said plurality of trays.

12. The power unit according to claim 1, wherein said cooking enclosure comprises:
a polyphenylsulfone (PPSU) dome;
a removable stainless steel pan comprising:
a lip, and
at least one raised rib in bottom;
a removable rack comprising at least one of:
a 3 inch high rack; or
a 4 inch high;
a base for receiving said stainless steel pan,
wherein said base comprises:
a plurality of handles,
at least one opening for cooling,
at least one protective band guard,
on a top surface, a plurality of silicone locators and at least one center post, and
on a bottom surface a plurality of feet; and
at least one optional stainless steel extender ring.

13. The power unit according to claim 1, wherein said programmable controller comprises:
storage memory for receiving a plurality of recipes,
wherein each recipe comprises a multi-stage recipe, and
wherein each stage comprises a temperature and a time period.

14. The power unit according to claim 13, wherein said programmable controller comprises:
storage memory for receiving said plurality of recipes comprises storage for up to 99 recipes, and
wherein said each recipe comprising said multi-stage recipe comprises up to a 5 stage recipe.

15. The power unit according to claim 1, wherein said dehydrating enclosure comprises:
an adapter for coupling to the power unit;
a bottom;
a plurality of trays,
wherein each said tray comprises:
at least one first portion of a coupler; and
at least one second portion of a coupler adapted to couple to said first portion of another of said plurality of trays.

16. The power unit according to claim 15, wherein said first portion comprises a hook, and said second portion comprises a hole.

17. The power unit according to claim 1, wherein said cooking enclosure comprises at least one of:
a dome enclosure;
a removable pan; or
a base for receiving said pan.

18. The power unit according to claim 17, comprising said dome enclosure and wherein said dome enclosure comprises: polyphenylsulfone (PPSU) material.

19. The power unit according to claim 17, wherein said pan comprises a stainless steel pan comprising at least one of:
a lip, or
at least one raised rib in a bottom.

20. The power unit according to claim 17, further comprising at least one of:
a) at least one extender ring comprising at least one of:
a polyphenylsulfone (PPSU) ring;
a ceramic ring;
a glass ring;
a stainless steel ring;
a metal ring; or
a ring adapted to stack atop at least one of:
said pan, or
another ring;
b) a removable rack comprising at least one of:
a 3 inch high rack; or
a 4 inch high; or
c) said base, wherein said base comprises at least one of:
at least one handle;
at least one opening for cooling;
at least one band guard;
at least one locator or post for supporting said pan; or
at least one foot for supporting said base.
